(19) United States
(12) Patent Application Publication
(10) Pub. No.: US 2026/0323718 A1
(43) Pub. Date: Oct. 15, 2026

(54) Random-Access in Asymmetric Transmission-and-Reception Points

(71) Applicant: Ofinno, LLC, Reston, VA (US)

(72) Inventors: Ali Cagatay Cirik, Chantilly, VA (US); Esmael Hejazi Dinan, McLean, VA (US)

(73) Assignee: Ofinno, LLC, Reston, VA (US)

(21) Appl. No.: 19/688,893

(22) Filed: May 27, 2026

Related U.S. Application Data
(63) Continuation of application No. PCT/US2025/052395, filed on Oct. 24, 2025.
(60) Provisional application No. 63/712,729, filed on Oct. 28, 2024.

(51) Int. Cl. H04W 74/0833; H04W 52/14; H04W 72/23

(52) U.S. Cl. CPC H04W 74/0833; H04W 52/143; H04W 72/23

(57) ABSTRACT

A wireless device receives one or more radio resource control (RRC) messages comprising one or more configuration parameters for a cell. The one or more configuration parameters comprise a pathloss offset parameter, for a downlink bandwidth part (BWP) of the cell, indicating that a pathloss offset indicator field is present in a downlink control information (DCI) format. The pathloss offset indicator field indicates a pathloss offset for a physical random-access channel (PRACH) transmission initiated by a physical downlink control channel (PDCCH) order. The wireless device receives, based on the DCI format, a first PDCCH order initiating a random-access procedure via the cell. A value of the pathloss offset indicator field indicates to apply a first pathloss offset associated with a first transmission configuration indicator (TCI) state to a first PRACH transmission. The wireless device transmits the first PRACH transmission using a transmission power based on the first pathloss offset.

### CROSS-REFERENCE TO RELATED APPLICATIONS

This application is a continuation of International Application No. PCT/US2025/052395, filed Oct. 24, 2025, which claims the benefit of U.S. Provisional Application No. 63/712,729, filed Oct. 28, 2024, each of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an aspect of an example embodiment according to the present disclosure.

FIGS. 18A and 18B illustrate aspects of example embodiments according to the present disclosure.

FIG. 19 illustrates an aspect of an example embodiment according to the present disclosure.

FIG. 20 illustrates an aspect of an example embodiment according to the present disclosure.

FIG. 21 illustrates a flowchart of an example embodiment according to the present disclosure.

FIG. 22 illustrates a flowchart of an example embodiment according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

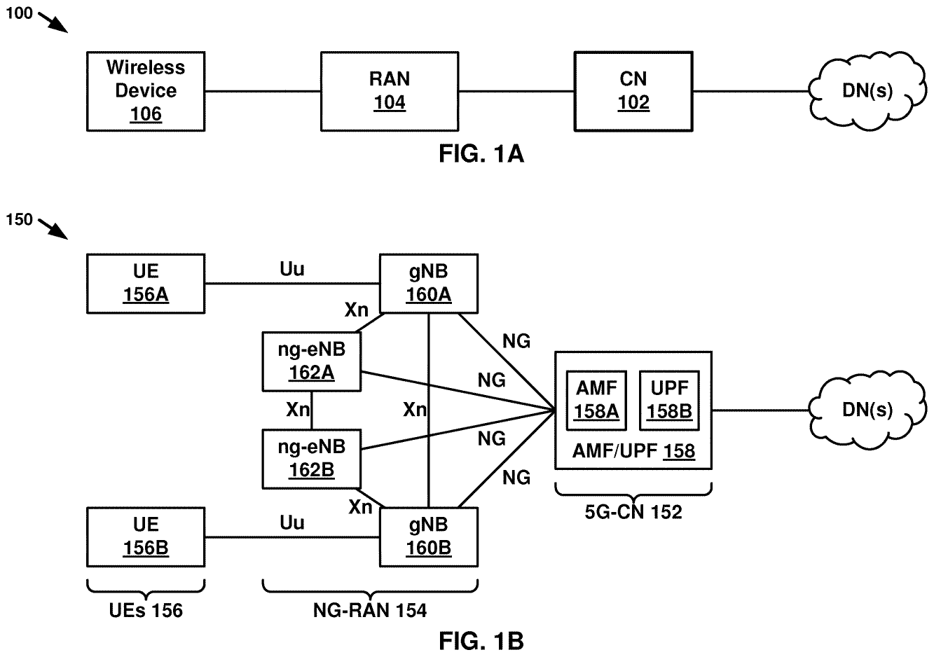

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

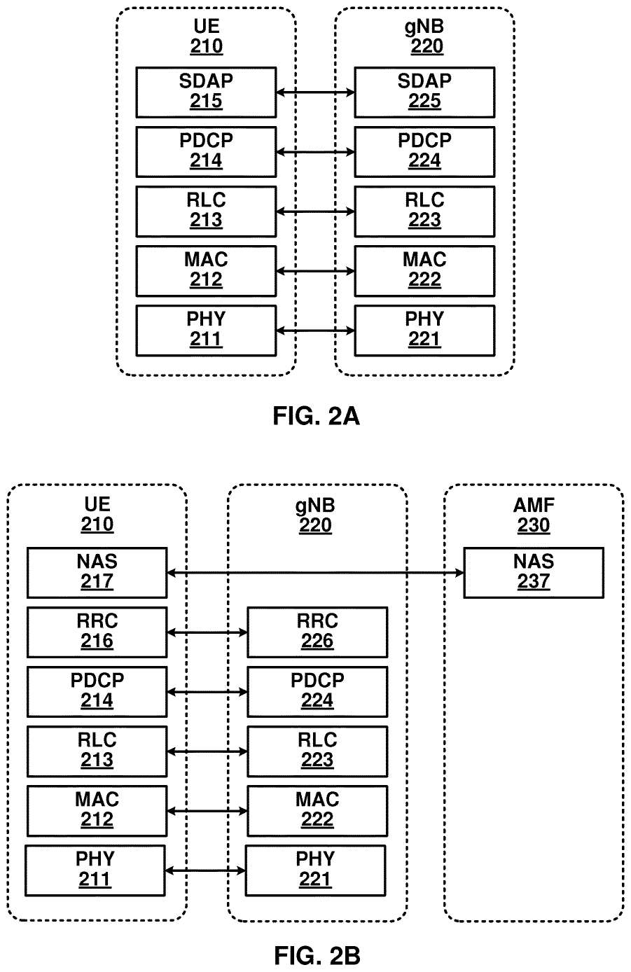

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

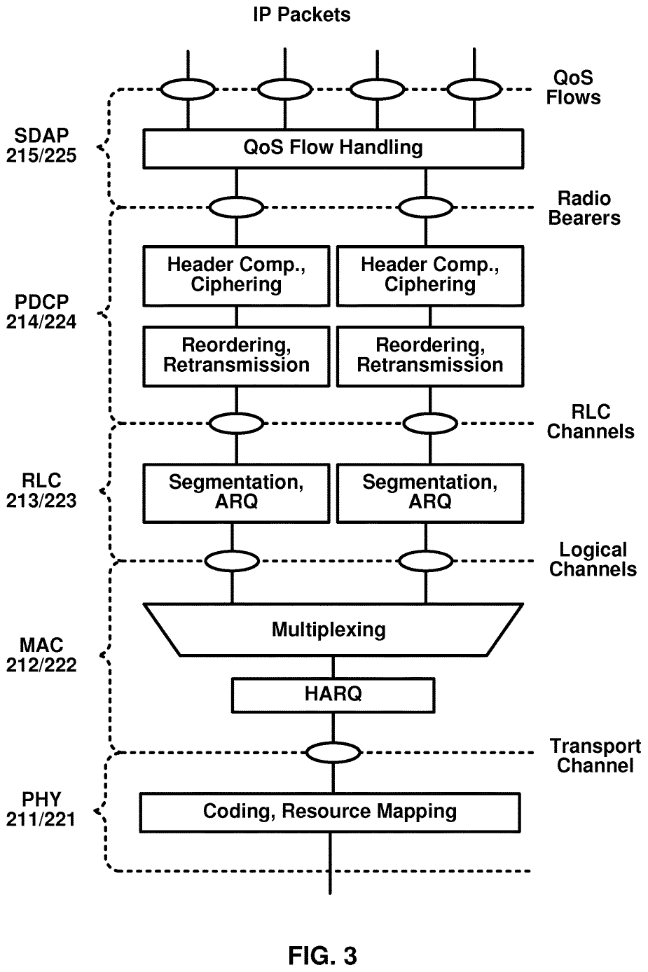

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

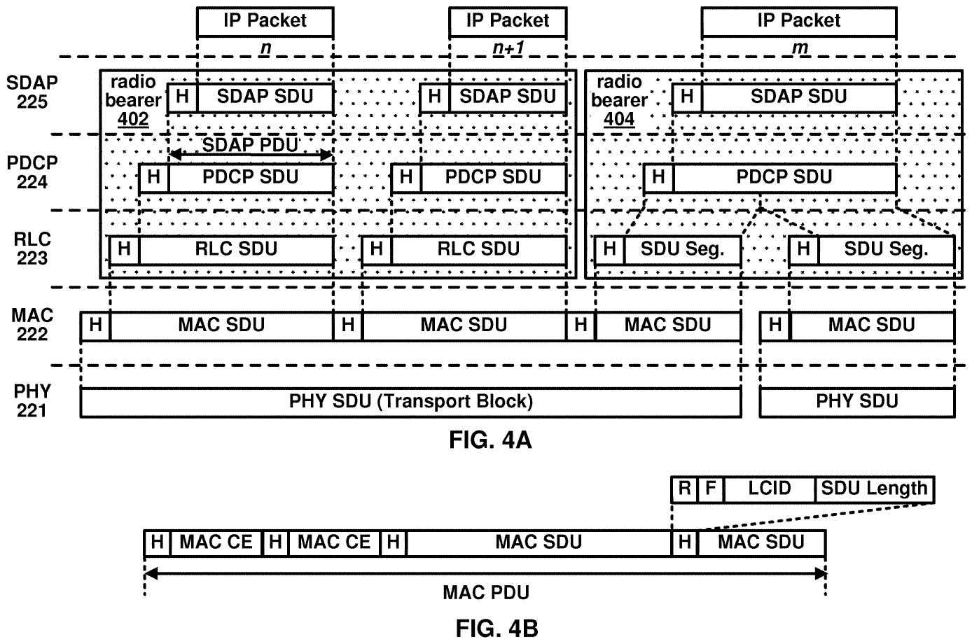

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

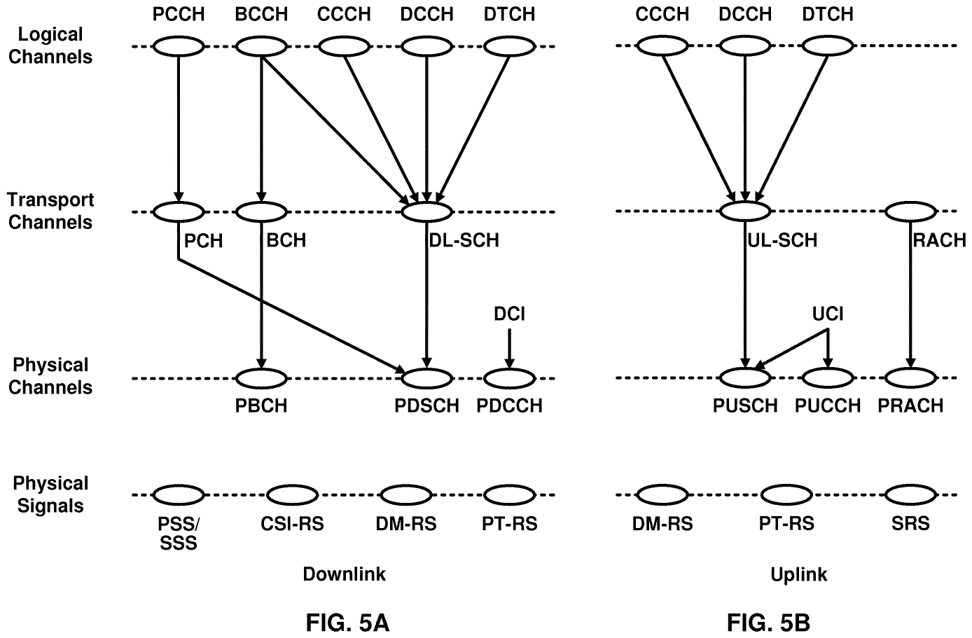

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

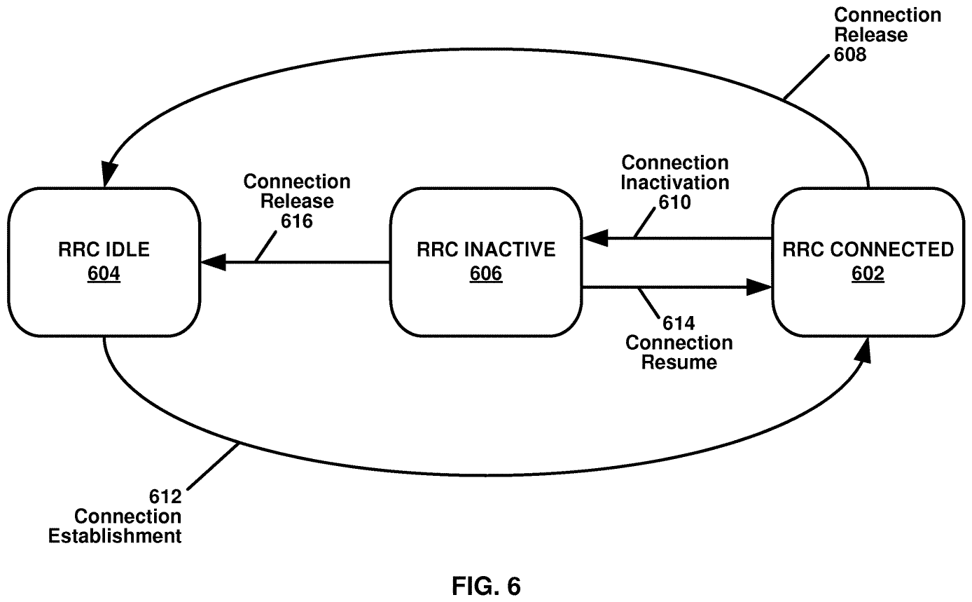

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

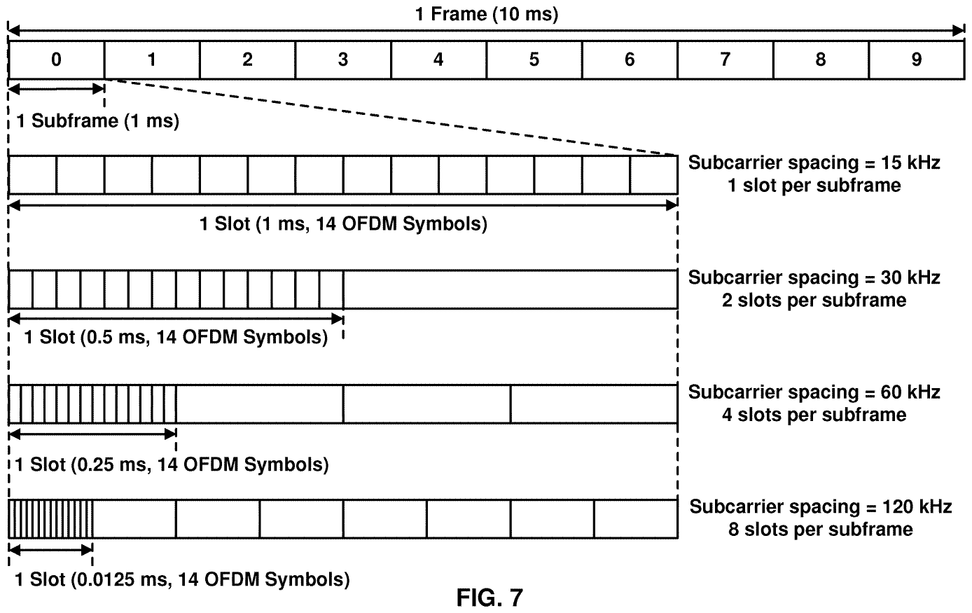

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

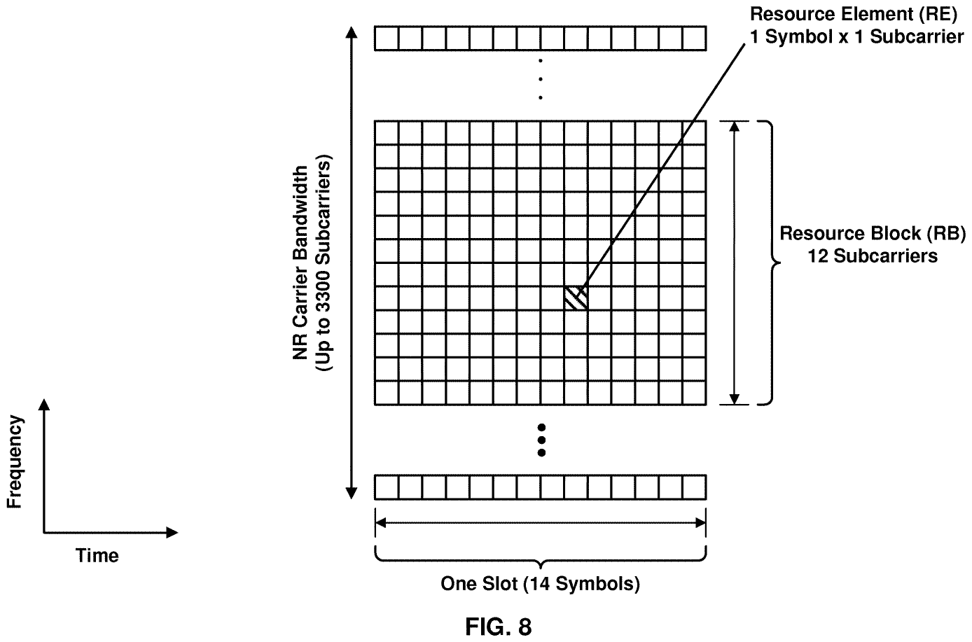

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

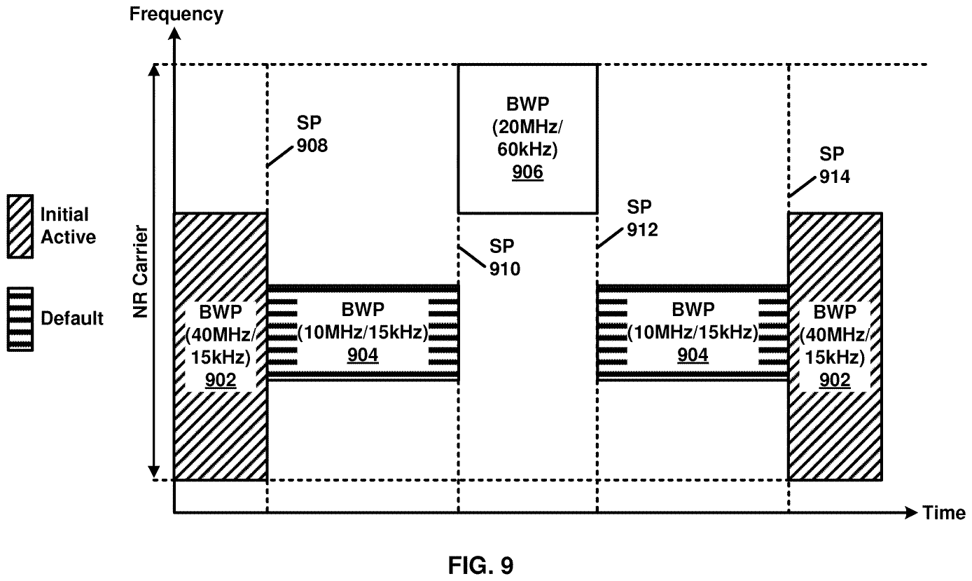

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

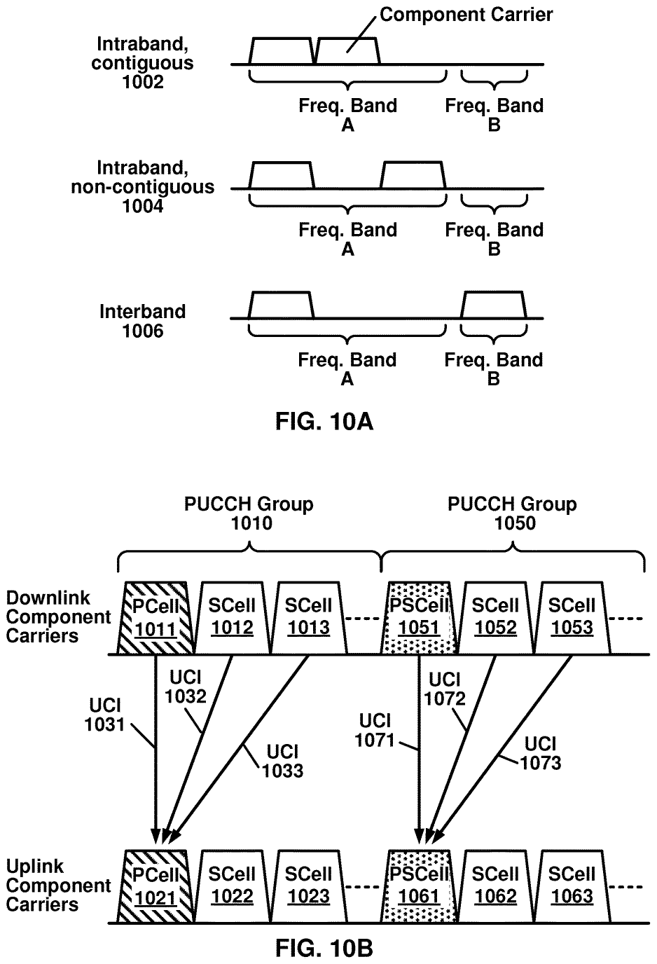

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

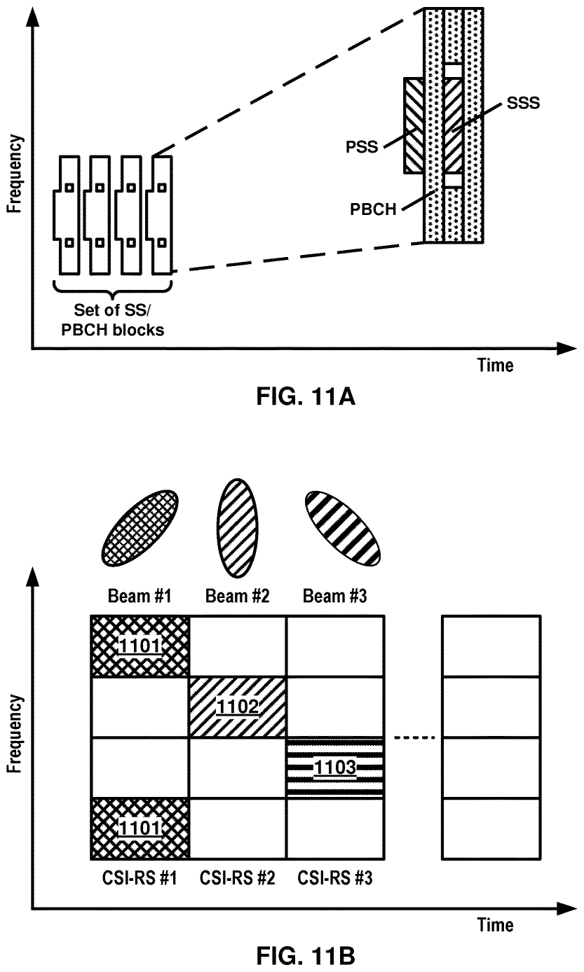

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

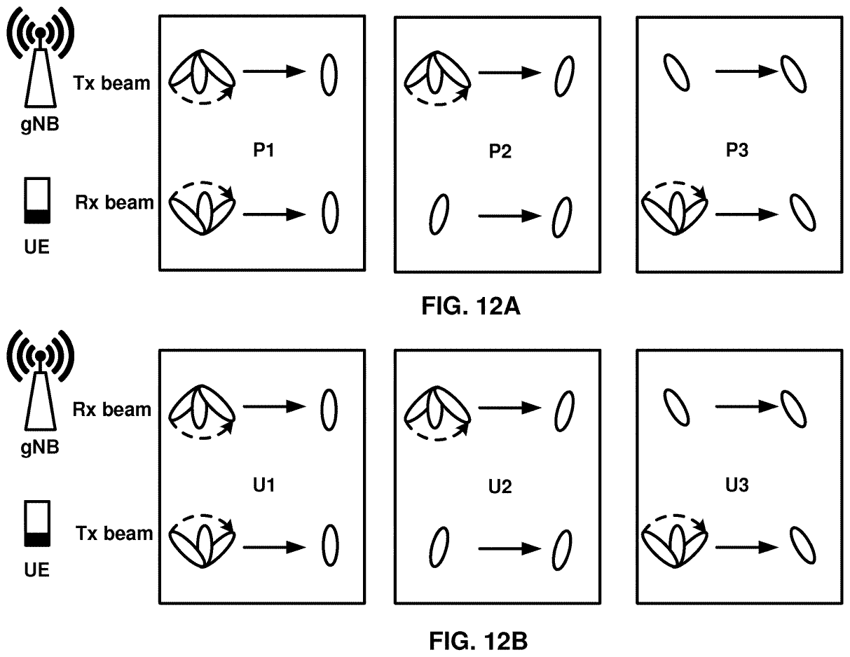

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

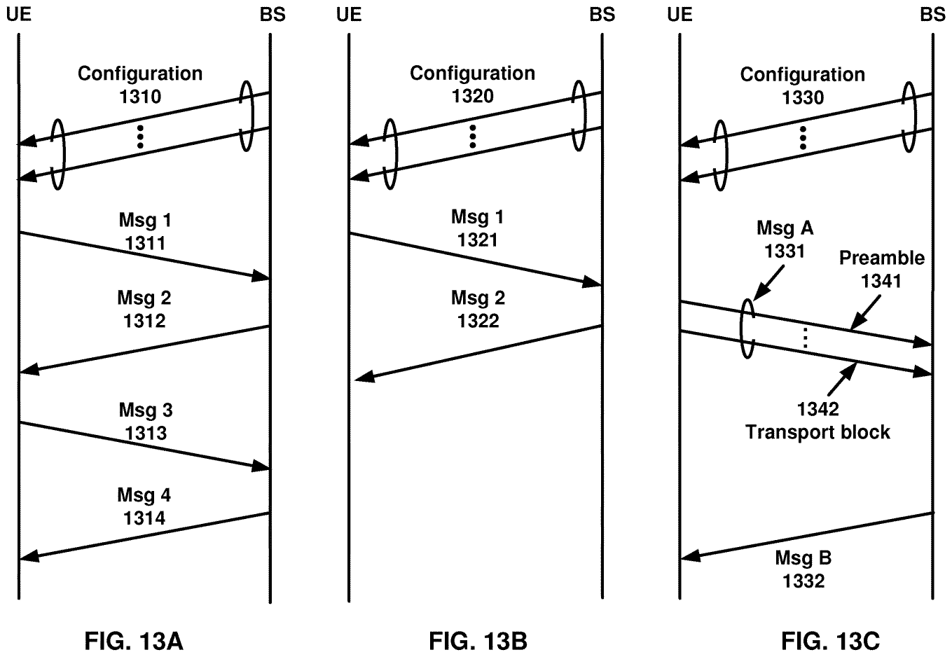

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

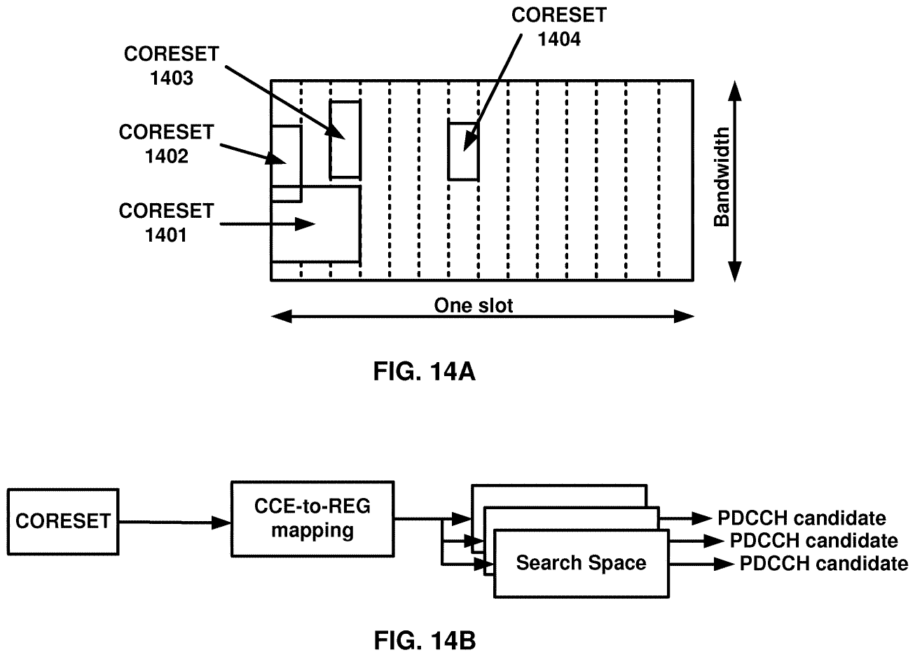

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g., a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

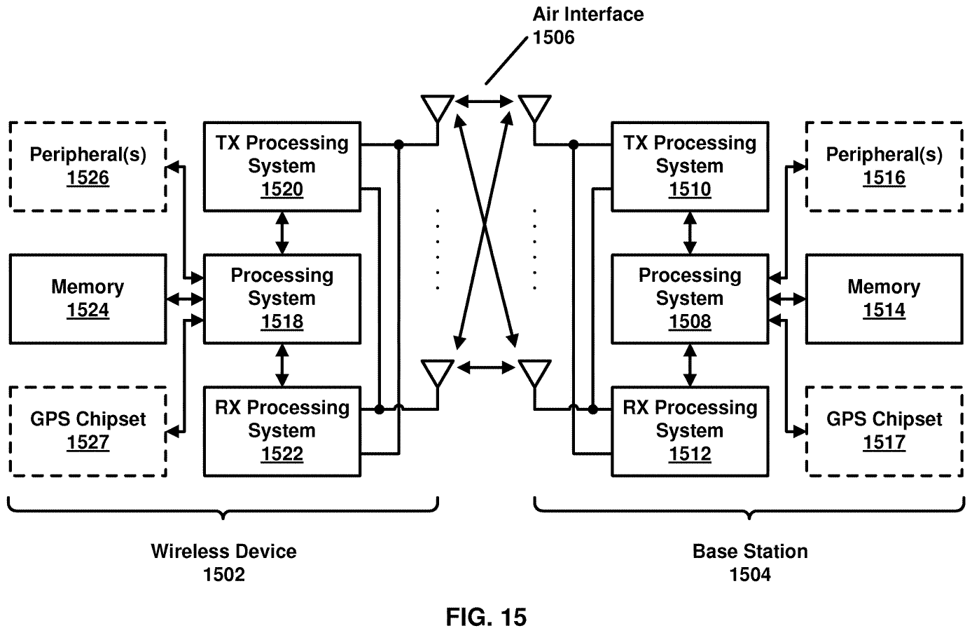

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

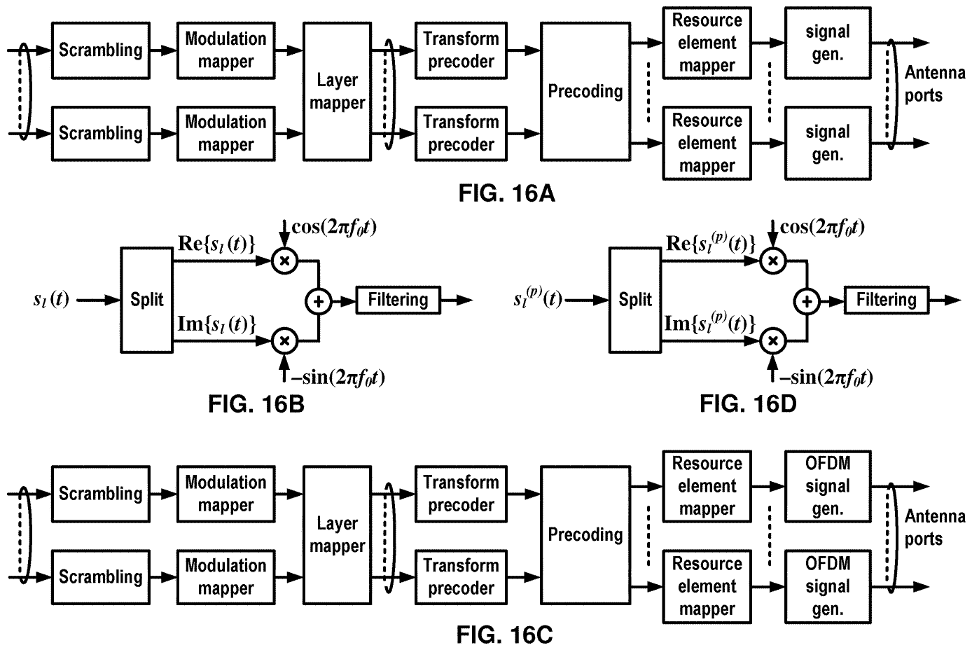

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

A wireless device may receive, e.g., from a base station, one or more messages comprising one or more configuration parameters.

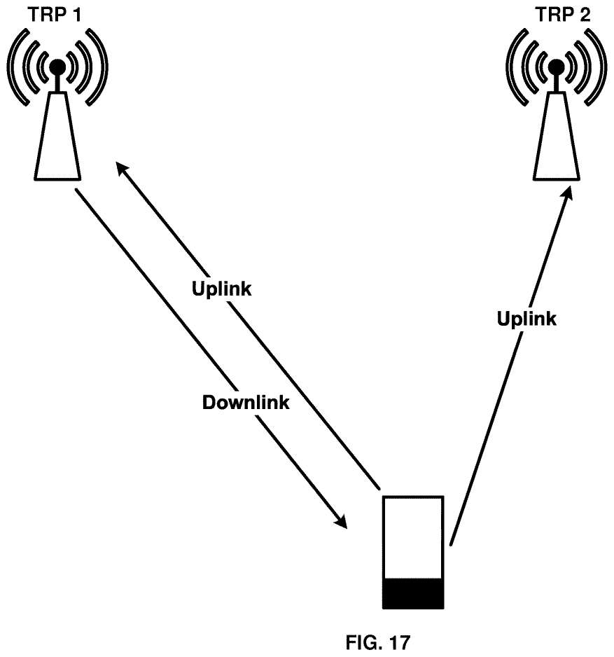

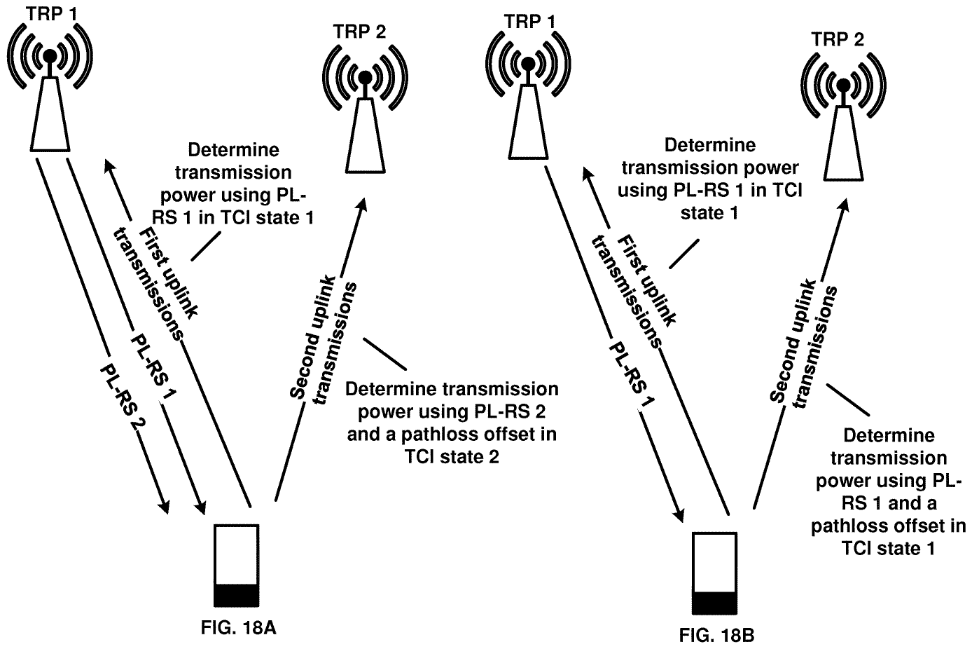

In an asymmetric TRP deployment (or asymmetric multi-TRP operation) as discussed in FIG. 17, FIG. 18A, and FIG. 18B, the wireless device may apply/use a pathloss offset associated with an indicated TCI state to determine a pathloss estimate for an uplink transmission if the wireless device transmits the uplink transmission to a TRP without downlink (e.g., uplink-only TRP).

The wireless device may receive/detect, from the base station, a control command (e.g., MAC-CE, DCI) indicating a TCI state for a cell (e.g., PCell, SCell, PSCell, SpCell, and the like).

The wireless device may detect/receive, from the base station, a PDCCH order initiating/triggering a random-access procedure for/on the cell.

The wireless device may transmit, using a transmission power, a PRACH transmission (or a random-access preamble) for/of the random-access procedure, for example, after receiving the PDCCH order initiating/triggering the random-access procedure.

In an example, the TCI state (or the indicated TCI state) indicated by the control command may be associated with a pathloss offset.

In the implementation of the existing technologies, the PDCCH order comprises a field indicating whether to apply the pathloss offset associated with the (indicated) TCI state or not to/for calculation/computation of the transmission power of the PRACH transmission. A first value (e.g., 0) of the field may indicate not to include/use the pathloss offset in calculation/computation of the transmission power. A second value (e.g., 1) of the field may indicate to include/use the pathloss offset in calculation/computation of the transmission power.

In an example, the TCI state (or the indicated TCI state) indicated by the control command may not be associated with a pathloss offset.

When the TCI state is not associated with a pathloss offset, in the implementation of the existing technologies, the wireless device may not know how to interpret the field in the PDCCH order. For example, when the field is equal/set to the second value (e.g., 1) indicating to apply a pathloss offset to/for calculation/computation of the transmission power the PRACH transmission, and if the TCI state is not associated with a pathloss offset, the wireless device may not know how to determine/calculate the transmission power of the PRACH transmission. This may result in inaccurate pathloss estimation.

The inaccurate pathloss estimation may lead to increased uplink interference leading to reduced data rate and increased error rates. This may result in unsuccessful completion of the random-access procedure.

Example embodiments enhance pathloss estimation of a PRACH transmission under an asymmetric TRP deployment (or asymmetric multi-TRP operation).

In an example embodiment, when the (indicated) TCI state is not associated with a pathloss offset, the wireless device may ignore the field (or a value of the field) in the PDCCH order. The pathloss reference signal used for calculation of the transmission power of/for the PRACH transmission may be the downlink reference signal that the DM-RS of the PDCCH order is quasi-collocated with.

In an example embodiment, when the (indicated) TCI state is not associated with a pathloss offset, the wireless device may expect a value of the field, in the PDCCH order, to be set/equal to a first value (e.g., 0). The wireless device may not expect the value of the field, in the PDCCH order, to be set/equal to a second value (e.g., 1). The pathloss reference signal used for calculation of the transmission power of/for the PRACH transmission may be the downlink reference signal that the DM-RS of the PDCCH order is quasi-collocated with.

The example embodiments may result in an accurate pathloss estimation. The accurate pathloss estimation may lead to decreased uplink interference leading to increased data rate and reduced error rates.

The wireless device may receive/detect, from the base station, a control command (e.g., MAC-CE, DCI) indicating two TCI states for the cell. The two TCI states may comprise a first TCI state and a second TCI state.

In the implementation of the existing technologies, the PDCCH order comprises a field indicating whether to apply a first pathloss offset associated with the first (indicated) TCI state or a second pathloss offset associated with the second (indicated) TCI state to/for calculation/computation of the transmission power of the PRACH transmission. A first value (e.g., 0) of the field may indicate to include/use the first pathloss offset in calculation/computation of the transmission power. A second value (e.g., 1) of the field may indicate to include/use the second pathloss offset in calculation/computation of the transmission power.

In an example, the two TCI states (or both of the two TCI states or each/any TCI state of the two TCI states) indicated by the control command may not be associated with a pathloss offset.

When the two TCI states are not associated with a pathloss offset, in the implementation of the existing technologies, the wireless device may not know how to interpret the field in the PDCCH order. For example, when the field is equal/set to the first value (e.g., 0) indicating to apply a pathloss offset associated with the first TCI state to/for calculation/computation of the transmission power the PRACH transmission, and if the first TCI state is not associated with a pathloss offset, the wireless device may not know how to determine/calculate the transmission power of the PRACH transmission. This may result in inaccurate pathloss estimation.

The inaccurate pathloss estimation may lead to increased uplink interference leading to reduced data rate and increased error rates. This may result in unsuccessful completion of the random-access procedure.

Example embodiments enhance pathloss estimation of a PRACH transmission under an asymmetric TRP deployment (or asymmetric multi-TRP operation).

In an example embodiment, when the two (indicated) TCI states are not associated with a pathloss offset, the wireless device may ignore the field (or a value of the field) in the PDCCH order.

In an example embodiment, when the two (indicated) TCI states are not associated with a pathloss offset, the field may be repurposed for indication of a pathloss reference signal for the PRACH transmission. For example, a first value (e.g., 0) of the field may indicate the downlink reference signal that the DM-RS of the PDCCH order is quasi-collocated with as the pathloss reference signal. For example, a second value (e.g., 1) of the field may indicate an SS/PBCH block indicated/identified by an SS/PBCH index field in the PDCCH order as the pathloss reference signal.

In an example embodiment, when a pathloss offset is configured/provided/indicated in/for at least one TCI state by the one or more configuration parameters, the wireless device may not expect both of the two TCI states not being associated with a pathloss offset.

In an example embodiment, when a pathloss offset is configured/provided/indicated in/for at least one TCI state by the one or more configuration parameters, the wireless device may expect at least one of the two TCI states being associated with a pathloss offset.

In an example embodiment, when a pathloss offset is configured/provided/indicated in/for at least one TCI state by the one or more configuration parameters, the wireless device may expect one of the two TCI states being associated with a pathloss offset.

In an example embodiment, when a pathloss offset is configured/provided/indicated in/for at least one TCI state by the one or more configuration parameters, the wireless device may expect only one of the two TCI states being associated with a pathloss offset.

The example embodiments may result in an accurate pathloss estimation. The accurate pathloss estimation may lead to decreased uplink interference leading to increased data rate and reduced error rates.

A wireless device may be configured with a list of TCI states (e.g., TCI-State) within/by a higher layer parameter PDSCH-Config to decode PDSCH according to a detected PDCCH with DCI intended for the wireless device and a given cell (e.g., a given serving cell, a given non-serving/candidate/target cell). A number of TCI states in the list may depend on a UE capability parameter maxNumberConfiguredTCIstatesPerCC. Each TCI state (e.g., TCI-State) may contain/comprise/include/indicate/have respective parameters for configuring a quasi co-location relationship between one or two downlink reference signals and DM-RS port(s) of a PDSCH, a DM-RS port of a PDCCH, or CSI-RS port(s) of a CSI-RS resource. The quasi co-location relationship may be configured by a higher layer parameter qcl-Type1 for a first downlink reference signal of the one or more downlink reference signals. The quasi co-location relationship may be configured by a higher layer parameter qcl-Type2 for a second downlink reference signal of the one or more downlink reference signals. When two downlink reference signals comprising a first downlink reference signal and a second downlink reference signal are indicated by a TCI state, QCL types of the two downlink reference signals may not be the same, regardless of whether the first downlink reference signal and the second downlink reference signal are the same or different. A quasi co-location type corresponding to a downlink reference signal of the one or more downlink reference signals may be given by a higher layer parameter qcl-Type in a higher layer parameter QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

A wireless device may be configured with a list of TCI states (e.g., up to 128 TCI-State configurations) within/by a higher layer parameter dl-OrJointTCI-StateList in PDSCH-Config. A TCI state (or a TCI state configuration) in the list of TCI states may contain/include/have/provide/comprise a reference signal for a quasi co-location for i) DM-RS of a PDSCH, ii) DM-RS of a PDCCH in a BWP/cell, and/or iii) a CSI-RS. A TCI state in the list of TCI states may provide/indicate a reference signal for determining uplink transmission spatial filter for i) a dynamic-grant PUSCH, ii) a configured-grant based PUSCH, iii) a PUCCH resource in a BWP/cell, and/or, iv) an SRS.

A wireless device may be configured with a list of TCI states (e.g., up to 64 TCI-UL State configurations) within a higher layer parameter ul-TCI-StateList in BWP-UplinkDedicated. A TCI state (e.g., TCI-UL-State or a TCI state configuration) in the list of TCI states may contain/include/have/provide/comprise a parameter for configuring a reference signal, if applicable, for determining uplink transmission spatial filter for i) dynamic-grant PUSCH transmissions, ii) configured-grant based PUSCH transmissions, iii) PUCCH transmissions via a PUCCH resource in a cell, and SRS transmissions.

A wireless device may receive an activation command (e.g., MAC-CE, DCI) used to map up to a number TCI states and/or pairs of TCI states (e.g., up to 8 TCI states and/or pairs of TCI states), with one TCI state for downlink channels/signals and/or one TCI state for uplink channels/signals, to codepoint(s) of a DCI field ‘Transmission Configuration Indication’ for one cell or for a set of cells/downlink BWPs, and/or up to a number of sets of TCI states (e.g., up to 8 sets of TCI states). Each set of the number of sets may be comprised of up to a number of TCI state(s) for downlink and uplink signals/channels (e.g., up to two TCI state(s)), or up to a number of TCI state(s) (e.g., up to two TCI state(s)) for downlink channels/signals and up to a number of TCI state(s) (e.g., up to two TCI state(s)) for uplink channels/signals to codepoint(s) of a DCI field ‘Transmission Configuration Indication’ for one cell or for a set of cells/downlink BWPs, and if applicable, for one cell or for a set of cells/uplink BWPs. When a set of TCI state IDs are activated, by the activation command, for a set of cells/downlink BWPs and if applicable, for a set of cells/uplink BWPs, where the applicable list of cells may be determined, by the wireless device, by an indicated cell in the activation command, the (same) set of TCI state IDs may be applied by the wireless device to/for all downlink and/or uplink BWPs in the indicated cells (or the applicable list of cells). If the activation command maps TCI-State(s) and/or TCI-UL-State(s) to only one (or to a single) TCI codepoint, the wireless device may apply the (indicated) TCI-State(s) and/or TCI-UL-State(s) to one cell or to a set of cells/downlink BWPs, and if applicable, to one cell or to a set of cells/uplink BWPs once the indicated mapping for the one single TCI codepoint is applied by the wireless device.

When tci-PresentInDCI is set as ‘enabled’ or tci-PresentDCI-1-2 is configured for a CORESET, a wireless device 1) configured with dl-OrJointTCI-StateList by one or more configuration parameters (e.g., RRC messages/parameters) and activated with TCI-State by the activation command, or 2) configured with ul-TCI-StateList by one or more configuration parameters (e.g., RRC messages/parameters) and activated with TCI-UL-State by the activation command may receive a DCI format (e.g., DCI format 1_1/1_2) providing/indicating TCI state(s) (e.g., TCI-State(s) and/or TCI-UL-State(s)) for a cell or all cells in the same cell list configured by a simultaneous TCI update parameter (e.g., simultaneousU-TCI-UpdateList1, simultaneousU-TCI-UpdateList2, simultaneousU-TCI-UpdateList3, simultaneousU-TCI-UpdateList4). The DCI format may be with or without a downlink assignment. The simultaneous TCI update parameter may be a higher layer parameter (e.g., RRC parameter).

When a wireless device configured with dl-OrJointTCI-StateList by one or more configuration parameters (e.g., RRC messages/parameters) transmits an uplink transmission (e.g., a PUCCH transmission, a PUSCH transmission) with a positive HARQ-ACK corresponding to the DCI format indicating the indicated TCI state(s) (e.g., TCI-State(s) and/or TCI-UL-State(s)), and if the indicated TCI State(s) is/are different from the previously indicated TCI state(s), the indicated TCI-State(s) may be applied, by the wireless device, starting from a first/starting/earliest slot that is at least a number of symbols (e.g., symbols) after the last symbol of the uplink transmission. The first/starting/earliest slot and the number of symbols may be both determined, by the wireless device, based on an active BWP with the smallest subcarrier spacing among BWP(s) of the cells applying the indicated TCI-State(s) that are active at the end of the uplink transmission carrying/with the positive HARQ-ACK. The number of symbols may be indicated/provided to the wireless device by RRC messages (e.g., one or more configuration parameters).

When a wireless device supports two TCI states in a codepoint of a DCI field ‘Transmission Configuration Indication’, the wireless device may receive an activation command (e.g., MAC-CE, DCI) used to map up to 8 combinations of one or two TCI states to codepoint(s) of the DCI field ‘Transmission Configuration Indication’. The wireless device may not expect to receive more than 8 TCI states in the activation command.

A wireless device may determine a transmission power for a physical random access channel (PRACH), P_{PRACH,b,f,c}(i), on active uplink BWP b of carrier f of cell c based on downlink reference signal (RS) for cell c in transmission occasion i as

P_{PRACH,b,f,c}(i)=min{P_{CMAX,f,c}(i), P_{PRACH,target,f,c}+PL_{b,f,c}} [dBm],
where
P_{CMAX,f,c}(i) is the wireless device configured maximum output power for carrier f of cell c within transmission occasion i,
P_{PRACH,target,f,c} is the PRACH target reception power PREAMBLE_RECEIVED_TARGET_POWER provided by higher layers for the active uplink BWP b of carrier f of cell c, and
PL_{b,f,c} is a pathloss for the active uplink BWP b of carrier f based on the downlink RS associated with the PRACH transmission on the active downlink BWP of cell c and calculated by the wireless device in dB as a higher layer parameter referenceSignalPower—higher layer filtered RSRP in dBm.

If a PRACH transmission from a wireless device is in response to a detection of a PDCCH order, by the wireless device, that triggers a contention-free random access procedure and depending on the downlink reference signal that the DM-RS of the PDCCH order is quasi co-located with:
when the PRACH association indicator is not present in the PDCCH order, or
when the cell indicator field in the PDCCH order is not present or has value 0, or
when a value of a PRACH association indicator field in the PDCCH order is 0 if the wireless device is not provided a higher layer parameter SSB-MTC-AdditionalPCI, or
when the PRACH association indicator field in the PDCCH order indicates a physCellId associated with the cell of the PDCCH order reception,
or depending on an SS/PBCH block indicated by the PDCCH order:
when the PRACH transmission is on a non-serving cell indicated by the cell indicator field in the PDCCH order, or
when a value of a PRACH association indicator field in the PDCCH order is 1 if the wireless device is not provided a higher layer parameter SSB-MTC-AdditionalPCI, or
when the PRACH association indicator field in the PDCCH order indicates a physCellId that is different that the physCellId associated with the cell of the PDCCH order reception,
the higher layer parameter referenceSignalPower may be provided by a corresponding higher layer parameter ss-PBCH-BlockPower. The higher layer parameter ss-PBCH-BlockPower may be an average EPRE of the resources elements that carry secondary synchronization signals in dBm that the base station used for SSB transmission.

When a value of a PRACH association indicator field in the PDCCH order is 1 if the wireless device is not provided a higher layer parameter SSB-MTC-AdditionalPCI, or when the PRACH association indicator field in the PDCCH order indicates a physCellId that is different that the physCellId associated with the cell of the PDCCH order reception, the wireless device may expect that the indicated SS/PBCH block in the PDCCH order is configured as pathlossReferenceRS-Id of an active TCI state.

If the wireless device is configured resources for a periodic CSI-RS reception, the higher layer parameter referenceSignalPower may be obtained by the higher layer parameter ss-PBCH-BlockPower and a higher layer parameter powerControlOffsetSS where the higher layer parameter powerControlOffsetSS provides an offset of CSI-RS transmission power relative to SS/PBCH block transmission power. If the higher layer parameter powerControlOffsetSS is not provided to the wireless device, the wireless device may assume an offset of 0 dB.

If a random access procedure is initiated by a PDCCH order to the wireless device, a PRACH transmission is with a same SCS as a PRACH transmission initiated by higher layers (e.g., MAC, RRC layers).

For a PRACH transmission by a wireless device triggered by a PDCCH order, the PRACH mask index field, if the value of the random access preamble index field is not zero, may indicate the PRACH occasion for the PRACH transmission where the PRACH occasions are associated with the SS/PBCH block index indicated by the SS/PBCH block index field of the PDCCH order and, if any, a cell indicator field indicates a cell for the PRACH transmission.

DCI format 1_0 may be used for the scheduling of PDSCH in one downlink cell.

The following information may be transmitted by means of the DCI format 1_0 with CRC scrambled by C-RNTI or CS-RNTI or MCS-C-RNTI:

Frequency domain resource assignment field: If the CRC of the DCI format 1_0 is scrambled by C-RNTI and the “Frequency domain resource assignment” field are set to one, the DCI format 1_0 may be for a random access procedure initiated by a PDCCH order, with all remaining fields set as follows:

Random Access Preamble index—6 bits according to ra-PreambleIndex.

UL/SUL indicator—1 bit. If the value of the “Random Access Preamble index” is not all zeros and if the wireless device is configured with supplementaryUplink in ServingCellConfig in the cell, this field may indicate which UL carrier in the cell to transmit the PRACH transmission; otherwise, this field is reserved.

SS/PBCH index—6 bits. If the value of the “Random Access Preamble index” is not all zeros, this field may indicate an SS/PBCH that may be used to determine the RACH occasion for the PRACH transmission; otherwise, this field is reserved.

PRACH Mask index—4 bits. If the value of the “Random Access Preamble index” is not all zeros, this field may indicate the RACH occasion associated with the SS/PBCH indicated by “SS/PBCH index” for the PRACH transmission; otherwise, this field is reserved.

Cell indicator—┌log₂(C+1)┐ bits indicating the cell for the corresponding PRACH transmission if the wireless device is configured with higher layer parameter EarlyUlSyncConfig, where C is the number of candidate cells configured with higher layer parameter EarlyUlSyncConfig; 0 bit otherwise.

PRACH association indicator—0 or 1 bit

1 bit if the wireless device is provided/configured/indicated, by the base station, with a higher layer parameter tag-Id2, and the wireless device is not provided/configured/indicated coresetPoolIndex or is provided coresetPoolIndex with value 0 for the first CORESETs, and is provided coresetPoolIndex with value 1 for the second CORESETs, or

This field may indicate the PCI associated with the PRACH transmission if the wireless device is provided SSB-MTC-AddtionalPCI. The bit field index 0 of this field may be mapped to the PCI of the serving cell, and the bit field index 1 of this field may be mapped to the active additional PCI.

This field may indicate the PL-RS for the PRACH transmission if the wireless device is not provided/configured/indicated a higher layer parameter SSB-MTC-AddtionalPCI. The bit field index 0 of this field may be mapped to the DL RS that the DM-RS of the PDCCH order is quasi co-located with, and the bit field index 1 of this field may be mapped to the SS/PBCH indicated by the SS/PBCH index field in this DCI format. 0 bit otherwise.

FIG. 17, FIG. 18A, and FIG. 18B illustrate examples of asymmetric uplink and downlink channels as per an aspect of an embodiment of the present disclosure.

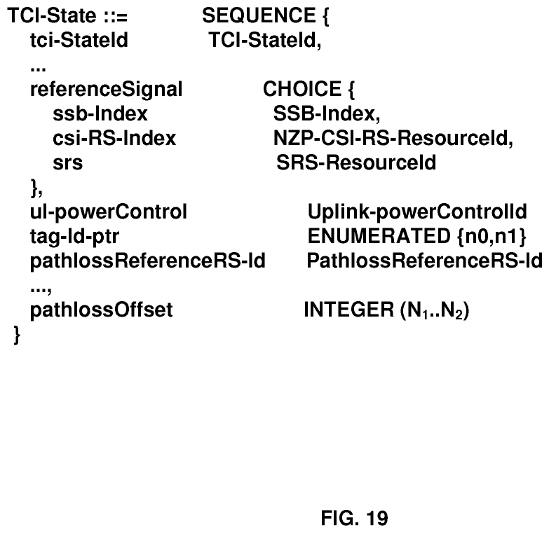

FIG. 19 illustrates an example of TCI state configuration as per an aspect of an embodiment of the present disclosure.

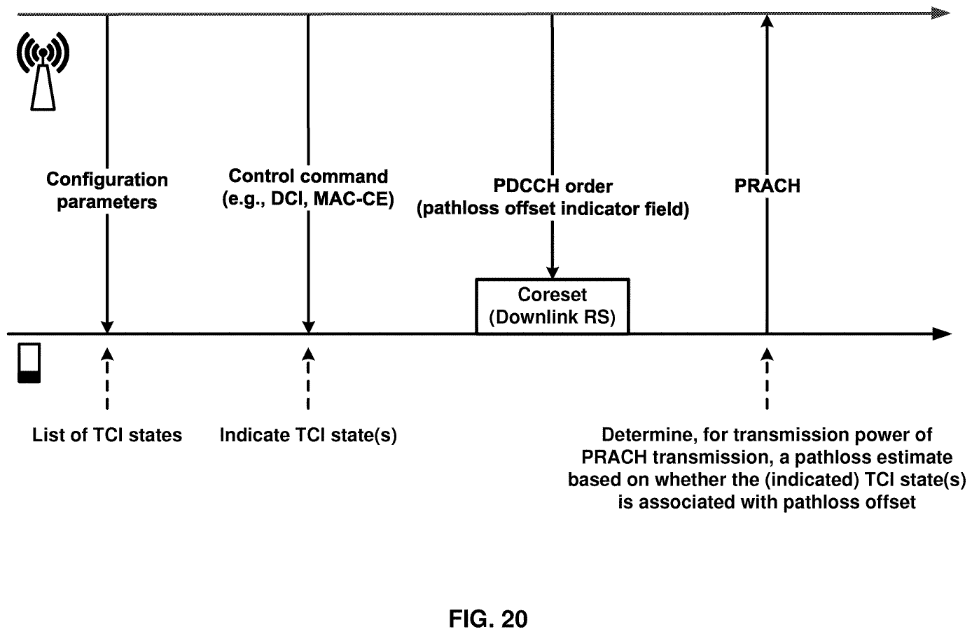

FIG. 20 illustrates an example of random-access procedure as per an aspect of an embodiment of the present disclosure.

In an example, a wireless device may receive one or more messages. In an example, the wireless device may receive the one or more messages from a base station. In an example, the wireless device may receive the one or more messages from a relay node. In an example, the wireless device may receive the one or more messages from another wireless device (e.g., TRP, vehicle, remote radio head, and the like). The one or more messages may comprise one or more configuration parameters (e.g., Configuration parameters in FIG. 20). In an example, the one or more configuration parameters may be RRC configuration parameter(s). In an example, the one or more configuration parameters may be RRC reconfiguration parameter(s).

In an example, the one or more configuration parameters may be for one or more cells.

The one or more cells may comprise a cell. The cell may be, for example, a serving cell. In an example, at least one configuration parameter of the one or more configuration parameters may be for the cell. In an example, the cell may be a primary cell (PCell). In an example, the cell may be a secondary cell (SCell). The cell may be a secondary cell configured with PUCCH (e.g., PUCCH SCell). In an example, the cell may be an unlicensed cell, e.g., operating in an unlicensed band. In an example, the cell may be a licensed cell, e.g., operating in a licensed band. In an example, the cell may operate in a first frequency range (FR1). The FR1 may, for example, comprise frequency bands below 6 GHz. In an example, the cell may operate in a second frequency range (FR2). The FR2 may, for example, comprise frequency bands from 24 GHz to 52.6 GHz. In an example, the cell may operate in a third frequency range (FR3). The FR3 may, for example, comprise frequency bands from 52.6 GHz to 71 GHz. The FR3 may, for example, comprise frequency bands starting from (or above) 52.6 GHz.

In an example, the wireless device may perform uplink transmissions (e.g., PUSCH, PUCCH, PUCCH) via/of the cell in a first time and in a first frequency. The wireless device may perform downlink receptions (e.g., PDCCH, PDSCH) via/of the cell in a second time and in a second frequency. In an example, the cell may operate in a time-division duplex (TDD) mode. In the TDD mode, the first frequency and the second frequency may be the same. In the TDD mode, the first time and the second time may be different. In an example, the cell may operate in a frequency-division duplex (FDD) mode. In the FDD mode, the first frequency and the second frequency may be different. In the FDD mode, the first time and the second time may be the same.

In an example, the wireless device may be in an RRC connected mode. In an example, the wireless device may be in an RRC idle mode. In an example, the wireless device may be in an RRC inactive mode.

In an example, the cell may comprise a plurality of BWPs. The plurality of BWPs may comprise one or more uplink BWPs comprising an uplink BWP of the cell. The plurality of BWPs may comprise one or more downlink BWPs comprising a downlink BWP of the cell.

In an example, a BWP of the plurality of BWPs may be in one of an active state and an inactive state. In an example, in the active state of a downlink BWP of the one or more downlink BWPs, the wireless device may monitor a downlink channel/signal (e.g., PDCCH, DCI, CSI-RS, PDSCH) on/for/via the downlink BWP. In an example, in the active state of a downlink BWP of the one or more downlink BWPs, the wireless device may receive a PDSCH on/via/for the downlink BWP. In an example, in the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In an example, in the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

In an example, in the active state of an uplink BWP of the one or more uplink BWPs, the wireless device may transmit an uplink signal/channel (e.g., PUCCH, preamble, PUSCH, PRACH, PUCCH, etc) on/via the uplink BWP. In an example, in the inactive state of an uplink BWP of the one or more uplink BWPs, the wireless device may not transmit an uplink signal/channel (e.g., PUCCH, preamble, PUSCH, PRACH, PUCCH, etc) on/via the uplink BWP.

In an example, the wireless device may activate the downlink BWP of the one or more downlink BWPs of the cell. In an example, the activating the downlink BWP may comprise setting (or switching to) the downlink BWP as an active downlink BWP of the cell. In an example, the activating the downlink BWP may comprise setting the downlink BWP in the active state. In an example, the activating the downlink BWP may comprise switching the downlink BWP from the inactive state to the active state.

In an example, the wireless device may activate the uplink BWP of the one or more uplink BWPs of the cell. In an example, the activating the uplink BWP may comprise that the wireless device sets (or switches to) the uplink BWP as an active uplink BWP of the cell. In an example, the activating the uplink BWP may comprise setting the uplink BWP in the active state. In an example, the activating the uplink BWP may comprise switching the uplink BWP from the inactive state to the active state.

In an example, the one or more configuration parameters may be for the (active) downlink BWP of the cell. In an example, at least one configuration parameter of the one or more configuration parameters may be for the downlink BWP of the cell.

In an example, the one or more configuration parameters may be for the (active) uplink BWP of the cell. In an example, at least one configuration parameter of the one or more configuration parameters may be for the uplink BWP of the cell.

The one or more configuration parameters may indicate a subcarrier spacing (or a numerology) for the downlink BWP.

The one or more configuration parameters may indicate a subcarrier spacing (or a numerology) for the uplink BWP.

A value of the subcarrier spacing (of the downlink BWP and/or the uplink BWP) may be/indicate, for example, 15 kHz (mu=0). A value of the subcarrier spacing may be/indicate, for example, 30 kHz (mu=1). A value of the subcarrier spacing may be/indicate, for example, 60 kHz (mu=2). A value of the subcarrier spacing may be/indicate, for example, 120 kHz (mu=3). A value of the subcarrier spacing may be/indicate, for example, 240 kHz (mu=4). A value of the subcarrier spacing may be/indicate, for example, 480 kHz (mu=5). A value of the subcarrier spacing may be/indicate, for example, 960 kHz (mu=6). For example, 480 kHz may be valid/applicable in FR3. For example, 960 kHz may be valid/applicable in FR3. For example, 240 kHz may be valid/applicable in FR3. For example, 120 kHz may be valid/applicable in FR3.

The one or more configuration parameters may comprise a first parameter (e.g., asymmetric-DL-sTRP-UL-mTRP, asymmetric-mTRP, asymmetric-TRP, uplink-only-TRP, DL-sTRP-UL-mTRP, asymmetric-DL-UL, enable-DL-sTRP-UL-mTRP, enable-asymmetric-DL-sTRP-UL-mTRP, enable-asymmetric-DL-UL, uplink-downlink, pathlossOffset, plOffset, pathlossOffsetIndicationDCI-1-0, pathlossOffset-PresentInDCI, and the like).

The first parameter may indicate whether a single TRP in the downlink and multiple TRPs in the uplink operation/mode is enabled/configured or not.

In an example, when the one or more configuration parameters comprise the first parameter, the wireless device may receive downlink receptions (e.g., PDCCH, PDSCH, CSI-RS, SS/PBCH blocks) from a first TRP (e.g., TRP 1 in FIG. 17). The wireless device may not receive downlink receptions (e.g., PDCCH, PDSCH, CSI-RS, SS/PBCH blocks) from a second TRP (e.g., TRP 2 in FIG. 17). The wireless device may transmit uplink transmissions (e.g., PUCCH, PUSCH, SRS) to the second TRP. In an example, the wireless device may transmit uplink transmissions (e.g., PUCCH, PUSCH, SRS) to both the first TRP and the second TRP.

In an example, when the first parameter is present/configured/provided in the one or more configuration parameters, the wireless device may receive downlink receptions (e.g., PDCCH, PDSCH, CSI-RS, SS/PBCH blocks) from a first TRP (e.g., TRP 1 in FIG. 17). The wireless device may not receive downlink receptions (e.g., PDCCH, PDSCH, CSI-RS, SS/PBCH blocks) from a second TRP (e.g., TRP 2 in FIG. 17). The wireless device may transmit uplink transmissions (e.g., PUCCH, PUSCH, SRS) to the second TRP. In an example, the wireless device may transmit uplink transmissions (e.g., PUCCH, PUSCH, SRS) to both the first TRP and the second TRP.

In an example, when the first parameter is enabled, the wireless device may receive downlink receptions (e.g., PDCCH, PDSCH, CSI-RS, SS/PBCH blocks) from a first TRP (e.g., TRP 1 in FIG. 17). The wireless device may not receive downlink receptions (e.g., PDCCH, PDSCH, CSI-RS, SS/PBCH blocks) from a second TRP (e.g., TRP 2 in FIG. 17). The wireless device may transmit uplink transmissions (e.g., PUCCH, PUSCH, SRS) to the second TRP. In an example, the wireless device may transmit uplink transmissions (e.g., PUCCH, PUSCH, SRS) to both the first TRP and the second TRP.

In an example, when the first parameter is set to a first value (e.g., ‘enabled’), the wireless device may receive downlink receptions (e.g., PDCCH, PDSCH, CSI-RS, SS/PBCH blocks) from a first TRP (e.g., TRP 1 in FIG. 17). The wireless device may not receive downlink receptions (e.g., PDCCH, PDSCH, CSI-RS, SS/PBCH blocks) from a second TRP (e.g., TRP 2 in FIG. 17). The wireless device may transmit uplink transmissions (e.g., PUCCH, PUSCH, SRS) to the second TRP. In an example, the wireless device may transmit uplink transmissions (e.g., PUCCH, PUSCH, SRS) to both the first TRP and the second TRP.

In an example, when the one or more configuration parameters do not comprise the first parameter, the wireless device may receive downlink receptions (e.g., PDCCH, PDSCH, CSI-RS, SS/PBCH blocks) from both a first TRP (e.g., TRP 1 in FIG. 17) and a second TRP (e.g., TRP 2 in FIG. 17). The wireless device may transmit uplink transmissions (e.g., PUCCH, PUSCH, SRS) to both the first TRP and the second TRP.

In an example, when the first parameter is not present/configured/provided (or is absent) in the one or more configuration parameters, the wireless device may receive downlink receptions (e.g., PDCCH, PDSCH, CSI-RS, SS/PBCH blocks) from both a first TRP (e.g., TRP 1 in FIG. 17) and a second TRP (e.g., TRP 2 in FIG. 17). The wireless device may transmit uplink transmissions (e.g., PUCCH, PUSCH, SRS) to both the first TRP and the second TRP.

In an example, when the first parameter is not enabled (or is disabled), the wireless device may receive downlink receptions (e.g., PDCCH, PDSCH, CSI-RS, SS/PBCH blocks) from both a first TRP (e.g., TRP 1 in FIG. 17) and a second TRP (e.g., TRP 2 in FIG. 17). The wireless device may transmit uplink transmissions (e.g., PUCCH, PUSCH, SRS) to both the first TRP and the second TRP.

In an example, when the first parameter is set to a second value (e.g., ‘disabled’, ‘not enabled’), the wireless device may receive downlink receptions (e.g., PDCCH, PDSCH, CSI-RS, SS/PBCH blocks) from both a first TRP (e.g., TRP 1 in FIG. 17) and a second TRP (e.g., TRP 2 in FIG. 17). The wireless device may transmit uplink transmissions (e.g., PUCCH, PUSCH, SRS) to both the first TRP and the second TRP.

A TRP is a physical point for network transmission and/or reception. Such a physical point may correspond, for example, to one or more sites within a cell or to geographically separated antennas of a distributed-antenna system. In multi-TRP operation, communication involving a wireless device (e.g., UE) may include downlink multi-point transmission and/or uplink multi-point reception. Downlink multi-point transmission may include downlink transmission from multiple points or TRPs to the same wireless device. Uplink multi-point reception may include reception at multiple points or TRPs of uplink transmissions from the same wireless device.

In asymmetric multi-TRP operation, communication involving the wireless device may include only downlink multi-point transmission or only uplink multi-point reception. An example shown in FIG. 17 includes a wireless device and TRP 1 and TRP 2. TRP 1 and TRP 2 may be associated with a single or multiple base stations. For example, TRP 1 may be associated with a first base station (e.g., a macro cell or a macro gNB) and TRP 2 may be associated with a second base station (e.g., a microcell, a picocell, or a femtocell). TRP 1 may support or enable both downlink transmission to the wireless device and uplink reception from the wireless device 2302. TRP 2 may support or enable only uplink reception from the wireless device. In an example, TRP 1, which supports or enables downlink transmission to the wireless device is referred to as an “anchor” or a “primary” TRP. In contrast, TRP 2, which supports or enables only uplink reception from the wireless device may be referred to as an “uplink-only” or a “secondary” TRP.

In accordance with example in FIG. 17, communication between the wireless device and the base station may include uplink multi-point reception but may not include downlink multi-point transmission. That is, the wireless device may transmit uplink transmissions to both TRP 1 and TRP 2 but may receive downlink transmissions from TRP 1 only. In an example, such an asymmetric multi-TRP operation may be referred to as a downlink single TRP, uplink multi-TRP (DL sTRP/UL mTRP) operation.

In another example (not shown in FIG. 17), communication between the wireless device and the base station may include downlink multi-point transmission but may not include uplink multi-point reception. For example, the wireless device may receive downlink transmissions from both TRP 1 and TRP 2 but may transmit uplink transmissions to TRP 1 only. Such an asymmetric multi-TRP operation may be referred to as downlink multi-TRP, uplink single TRP (DL mTRP/UL sTRP) operation.

In transmitting to a TRP, a wireless device may use/apply a TCI state configured/activated/indicated for the TRP. Specifically, the wireless device may use the TCI state to determine a beam (or a spatial domain filter) for an uplink transmission to the TRP. In an implementation, as illustrated in FIG. 19, the TCI state indicates one or more reference signals (e.g., SSB, CSI-RS, SRS) that the wireless device may use to determine the spatial domain filter for the uplink transmission to the TRP. After receiving the one or more reference signals, the wireless device may assume that a beam established for reception of the one or more reference signals may also be used for transmitting the uplink transmission to the TRP.

Additionally, a wireless device may use power control to regulate its uplink transmit power for an uplink transmission to the TRP. In symmetric multi-TRP operation, each TRP may be used for both downlink transmission and for uplink reception. As such, the wireless device may use downlink transmissions from a TRP to estimate a pathloss of a downlink channel from the TRP to the wireless device. In an implementation, a downlink pathloss reference signal (DL PL-RS) may be transmitted from the TRP to enable the wireless device to measure/estimate the pathloss of the downlink channel. In an implementation, as illustrated in FIG. 19, an identifier of the downlink pathloss reference signal (e.g., pathlossReferenceRS-Id) may be indicated in the TCI state configured/activated/indicated for the TRP. Assuming reciprocity between the downlink channel from the TRP and an uplink channel to the TRP, the wireless device may use the measured/estimated pathloss of the downlink channel to determine a transmit power for an uplink transmission to the TRP.

In asymmetric multi-TRP operation, a problem that arises is that the wireless device does not receive downlink transmissions from an uplink-only TRP. The wireless device thus may not be able to measure/estimate a pathloss for use in uplink power control for uplink transmissions to the uplink-only TRP. A solution to this problem assumes that a channel from the uplink-only TRP to the wireless device may be related to a channel from an anchor TRP to the wireless device. As such, the pathloss to be used for power control for uplink transmissions to the uplink-only TRP may be related to the pathloss to be used for power control for uplink transmissions to the anchor TRP. In an implementation, the solution includes indicating in the TCI state configured/activated/indicated for the uplink-only TRP a downlink reference signal, transmitted by the anchor TRP, for measuring/estimating a pathloss and a pathloss offset for applying to the measured/estimated pathloss. FIG. 18A and FIG. 18B illustrate examples of such a solution. The examples shown in FIG. 18A and FIG. 18B include a wireless device and TRP 1 and TRP 2 described with reference to FIG. 17 above. As discussed above, TRP 1 may be an anchor TRP, while TRP 2 may be an uplink-only TRP.

In an implementation, in FIG. 18A, a first TCI state (e.g., TCI state 1 in FIG. 18A) may be configured/activated/indicated for TRP 1, and a second TCI state (e.g., TCI state 2 in FIG. 18A) may be configured/activated/indicated for TRP 2. The first TCI state may indicate a first downlink pathloss reference signal (e.g., PL-RS 1). The second TCI state may indicate a second downlink pathloss reference signal (e.g., PL-RS 2). The first and second downlink pathloss reference signals may be the same or different. Additionally, as illustrated in FIG. 18A, the second TCI state may indicate a pathloss offset.

In operation, TRP 1 may be configured to transmit both the first and second downlink pathloss reference signals. To transmit a first uplink transmission (e.g., PUSCH, PUCCH, SR) to TRP 1, the wireless device may be configured to measure/estimate a first pathloss based on receiving the first downlink pathloss reference signal (e.g., PL-RS 1) and to use the first pathloss to determine a first transmit power for the first uplink transmission to TRP 1. The wireless device may transmit the first uplink transmission to TRP 1 using the first transmit power and the first TCI state. To transmit a second uplink transmission to TRP 2, the wireless device may be configured to measure/estimate a second pathloss based on receiving the second downlink pathloss reference signal (e.g., PL-RS 2) and to adjust the second pathloss using the pathloss offset indicated in the second TCI state. Depending on implementation, the wireless device may add the pathloss offset to the second pathloss or may subtract the pathloss offset from the second pathloss, to obtain an adjusted second pathloss. The wireless device may use the adjusted second pathloss to determine a second transmit power for the second uplink transmission to TRP 2. The wireless device may transmit the second uplink transmission to TRP 2 using the second transmit power and the second TCI state.

In an implementation, in FIG. 18B, a first TCI state (e.g., TCI state 1 in FIG. 18B) may be configured/activated/indicated for TRP 1 and TRP 2. The first TCI state may indicate a first downlink pathloss reference signal (e.g., PL-RS 1). Additionally, as illustrated in FIG. 18B, the first TCI state may indicate a pathloss offset.

In operation, TRP 1 may be configured to transmit the first downlink pathloss reference signal. To transmit a first uplink transmission (e.g., PUSCH, PUCCH, SR) to TRP 1, the wireless device may be configured to measure/estimate a first pathloss based on receiving the first downlink pathloss reference signal (e.g., PL-RS 1) and to use the first pathloss to determine a first transmit power for the first uplink transmission to TRP 1. To transmit the first uplink transmission to TRP 1, the wireless device may not be configured to adjust the first pathloss using the pathloss offset indicated in the first TCI state. The wireless device may transmit the first uplink transmission to TRP 1 using the first transmit power and the first TCI state. To transmit a second uplink transmission to TRP 2, the wireless device may be configured to adjust the first pathloss using the pathloss offset indicated in the first TCI state. Depending on implementation, the wireless device may add the pathloss offset to the first pathloss or may subtract the pathloss offset from the first pathloss, to obtain an adjusted first pathloss. The wireless device may use the adjusted first pathloss to determine a second transmit power for the second uplink transmission to TRP 2. The wireless device may transmit the second uplink transmission to TRP 2 using the second transmit power and the first TCI state.

FIG. 19 illustrates an example of TCI state configuration as per an aspect of an embodiment of the present disclosure.

The one or more configuration parameters may indicate a plurality of TCI states for the cell. The one or more configuration parameter may comprise a TCI state list parameter (e.g., provided by a higher layer (e.g., RRC) parameter dl-OrJoint-TCIStateList) indicating a TCI state list (e.g., List of TCI states in FIG. 20). The TCI state list may comprise the plurality of TCI states. The one or more configuration parameters may comprise one or more PDSCH configuration parameters (e.g., PDSCH-Config), for example, comprising the TCI state list parameter that indicates the plurality of TCI states.

The one or more configuration parameters may indicate, for the plurality of TCI states, a plurality of TCI state indexes/identifiers/identities (e.g., TCI-StateId). The one or more configuration parameters may indicate, for each TCI state of the plurality of TCI states, a respective TCI state index of the plurality of TCI state indexes. Each TCI state of the plurality of TCI states may be indicated/identified by a respective TCI state index of the plurality of TCI state indexes. For example, the one or more configuration parameters may indicate, for a first TCI state of the plurality of TCI states, a first TCI state index of the plurality of TCI state indexes. The one or more configuration parameters may indicate, for a second TCI state of the plurality of TCI states, a second TCI state index of the plurality of TCI state indexes.

The one or more configuration parameters may indicate the plurality of TCI states that indicate a unified TCI state for the cell.

The one or more configuration parameters may comprise the one or more PDSCH configuration parameters, for example, for/of a downlink BWP (e.g., an active downlink BWP) of the cell. The one or more configuration parameters indicate the plurality of TCI states for the downlink BWP of the cell. The one or more PDSCH configuration parameters of the downlink BWP of the cell may comprise the TCI state list parameter (e.g., provided by a higher layer (e.g., RRC) parameter dl-OrJoint-TCIStateList) indicating the TCI state list.

The one or more configuration parameters may comprise the one or more PDSCH configuration parameters, for example, for a second downlink BWP of a second cell. The one or more cells may comprise the second cell. The one or more configuration parameters indicate the plurality of TCI states for the second downlink BWP of the second cell. The one or more PDSCH configuration parameters of the second downlink BWP of the second cell may comprise the TCI state list parameter (e.g., provided by a higher layer (e.g., RRC) parameter dl-OrJoint-TCIStateList) indicating the TCI state list. The one or more configuration parameters may comprise, for/of the downlink BWP of the cell, a reference unified TCI state list parameter (e.g., unifiedTCI-StateRef) indicating the second downlink BWP of the second cell. The reference unified TCI state list parameter may comprise a BWP index (e.g., BWP-Id) identifying/indicating the second downlink BWP. The reference unified TCI state list parameter may comprise a cell index (e.g., ServCellIndex) identifying/indicating the second cell. The second downlink BWP of the second cell may be a reference BWP of a reference cell for the downlink BWP of the cell. The downlink BWP of the cell may be a target BWP of a target cell. One or more PDSCH configuration parameters of the downlink BWP of the cell may not comprise a higher layer (e.g., RRC) parameter dl-OrJoint-TCIStateList, for example, based on the one or more configuration parameters comprising, for the downlink BWP of the cell, the reference unified TCI state list parameter.

The one or more configuration parameters may comprise a unified-TCI-state-type parameter (e.g., unifiedtci-StateType). The one or more configuration parameters may comprise one or more serving cell parameters (e.g., ServingCellConfig) comprising the unified-TCI-state-type parameter. The unified-TCI-state-type parameter may indicate the unified TCI state type of the cell.

For example, the unified-TCI-state-type parameter may be set to “Joint”. The wireless device may use/apply the plurality of TCI states (e.g., provided/indicated by dl-OrJoint-TCIStateList) for both uplink transmissions (e.g., PUSCH/PUCCH/SRS transmissions) of/via the cell and downlink receptions (e.g., PDCCH/PDSCH/CSI-RS receptions) of/via the cell, for example, based on the one or more configuration parameters comprising the unified-TCI-state-type parameter set to “Joint”. The plurality of TCI states may be, for example, a plurality of joint TCI states.

For example, the unified-TCI-state-type parameter may be set to “Separate”. The wireless device may use/apply the plurality of TCI states (e.g., provided/indicated by a higher layer parameter dl-OrJoint-TCIStateList) for downlink receptions (e.g., PDCCH/PDSCH/CSI-RS receptions) of/via the cell, for example, based on the one or more configuration parameters comprising the unified-TCI-state-type parameter set to “Separate”. The wireless device may not use/apply the plurality of TCI states for uplink transmissions (e.g., PUSCH/PUCCH/SRS transmissions) of/via the cell, for example, based on the one or more configuration parameters comprising the unified-TCI-state-type parameter set to “Separate”. The plurality of TCI states may be, for example, a plurality of downlink TCI states.

The one or more configuration parameters may indicate a second plurality of TCI states. The one or more configuration parameters may comprise an TCI state list parameter (e.g., provided/indicated by a higher layer parameter ul-TCI-StateList) indicating the TCI state list. The TCI state list may comprise the second plurality of TCI states. The one or more configuration parameters may comprise one or more uplink BWP configuration parameters comprising the TCI state list parameter that indicates the second plurality of TCI states.

The one or more configuration parameters may comprise the one or more uplink BWP configuration parameters, for example, for an uplink BWP (e.g., an active uplink BWP) of the cell. The one or more configuration parameters indicate the second plurality of TCI states for the uplink BWP of the cell. The one or more uplink BWP configuration parameters of the uplink BWP of the cell may comprise the TCI state list parameter (e.g., provided by a higher layer (e.g., RRC) parameter dl ul-TCI-StateList) indicating the TCI state list.

The one or more configuration parameters may comprise the one or more uplink BWP configuration parameters, for example, for a second uplink BWP of a second cell. The one or more configuration parameters indicate the second plurality of TCI states for the second uplink BWP of the second cell. The one or more uplink BWP configuration parameters of the second uplink BWP of the second cell may comprise the TCI state list parameter (e.g., provided by a higher layer (e.g., RRC) parameter dl ul-TCI-StateList) indicating the TCI state list. The one or more configuration parameters may comprise, for the uplink BWP of the cell, a reference unified TCI state list parameter (e.g., unifiedTCI-StateRef) indicating the second uplink BWP of the second cell. The reference unified TCI state list parameter may comprise a BWP index (e.g., BWP-Id) identifying/indicating the second uplink BWP. The reference unified TCI state list parameter may comprise a cell index (e.g., ServCellIndex) identifying/indicating the second cell. The second uplink BWP of the second cell may be a reference BWP of a reference cell for the uplink BWP of the cell. The uplink BWP of the cell may be a target BWP of a target cell. One or more uplink BWP configuration parameters of the uplink BWP of the cell may not comprise a higher layer (e.g., RRC) parameter ul-TCI-StateList, for example, based on the one or more configuration parameters comprising, for the uplink BWP of the cell, the reference unified TCI state list parameter.

The one or more configuration parameters may indicate, for the second plurality of TCI states, a plurality of TCI state indexes/identifiers/identities (e.g., TCI-StateId). The one or more configuration parameters may indicate, for each TCI state of the second plurality of TCI states, a respective TCI state index of the plurality of TCI state indexes. Each TCI state of the second plurality of TCI states may be indicated/identified by a respective TCI state index of the plurality of TCI state indexes. For example, the one or more configuration parameters may indicate, for a first TCI state of the second plurality of TCI states, a first TCI state index of the plurality of TCI state indexes. The one or more configuration parameters may indicate, for a second TCI state of the second plurality of TCI states, a second TCI state index of the plurality of TCI state indexes.

The wireless device may use/apply the second plurality of TCI states for uplink transmissions (e.g., PUSCH/PUCCH/SRS transmissions) of/via the cell, for example, based on the one or more configuration parameters comprising the unified-TCI-state-type parameter set to “Separate”. The wireless device may not use/apply the second plurality of TCI states for downlink receptions (e.g., PDCCH/PDSCH/CSI-RS receptions) of/via the cell, for example, based on the one or more configuration parameters comprising the unified-TCI-state-type parameter set to “Separate”. The second plurality of TCI states may be, for example, a plurality of uplink TCI states.

In an example, the wireless device may use, for downlink receptions via the downlink BWP of the cell, the plurality of TCI states, for example based on the one or more configuration parameters indicating the plurality of TCI states for the downlink BWP of the cell.

In an example, the wireless device may use, for uplink transmissions receptions via the uplink BWP of the cell, the plurality of TCI states, for example based on the one or more configuration parameters indicating the plurality of TCI states for the downlink BWP of the cell.

In an example, the wireless device may use, for downlink receptions via the downlink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the plurality of TCI states of the second downlink BWP of the second cell, for example, based on the reference unified TCI state list parameter indicating, for the downlink BWP of the cell, the second downlink BWP of the second cell.

In an example, the wireless device may use, for uplink transmissions receptions via the uplink BWP of the cell, the second plurality of TCI states, for example based on the one or more configuration parameters indicating the second plurality of TCI states for the uplink BWP of the cell.

In an example, the wireless device may use, for uplink transmissions receptions via the uplink BWP of the cell, the second plurality of TCI states of the second uplink BWP of the second cell, for example, based on the reference unified TCI state list parameter indicating, for the uplink BWP of the cell, the second uplink BWP of the second cell.

In an example, the cell may be served by a plurality of TRPs comprising a first TRP and a second TRP. The wireless device may be served by the plurality of TRPs via the cell.

The wireless device may receive, via the cell, a first downlink reception (e.g., PDSCH, PDCCH, CSI-RS) from the first TRP. The first TRP may transmit, to the wireless device, the first downlink reception. The wireless device may receive, via the cell, a second downlink reception (e.g., PDSCH, PDCCH, CSI-RS) from the second TRP. The second TRP may transmit, to the wireless device, the second downlink reception.

The wireless device may transmit, via the cell, a first uplink transmission (e.g., PUSCH, PUCCH, SRS) to the first TRP. The first TRP may receive, from the wireless device, the first uplink transmission. The wireless device may transmit, via the cell, a second uplink transmission (e.g., PUSCH, PUCCH, SRS) to the second TRP. The second TRP may receive, from the wireless device, the second uplink transmission.

In an example, the wireless device may receive an activation command (e.g., MAC-CE, MAC-CE, DCI, RRC, one or more control commands, one or more downlink control commands/messages, one or more control commands/messages, Unified TCI States Activation/Deactivation MAC CE, Enhanced Unified TCI States Activation/Deactivation MAC CE, The Enhanced Unified TCI States Activation/Deactivation MAC-CE for Joint TCI State Mode, Enhanced Unified TCI States Activation/Deactivation MAC-CE for Separate TCI State Mode, and the like).

For example, the activation command may indicate activation/indication of a subset of TCI states of the plurality of TCI states (e.g., DLorJoint-TCIStateList). The subset of TCI states may be, for example, a subset of joint TCI states of the plurality of joint TCI states. The subset of TCI states may be, for example, a subset of downlink TCI states of the plurality of downlink TCI states.

For example, the activation command may indicate activation/indication of a subset of TCI states of the second plurality of TCI states (e.g., ul-TCI-StateList). The subset of TCI states may be, for example, a subset of uplink TCI states of the plurality of uplink TCI states.

The base station may activate and/or deactivate the subset of TCI states, for example, by sending/transmitting the activation command.

The wireless device may map the subset of TCI states to one or more TCI codepoints of/for the cell. The activation command may indicate mapping of the subset of TCI states to the one or more TCI codepoints. The wireless device may map respective TCI state(s) of the subset of TCI states to a respective TCI codepoint of the one or more TCI codepoints. The one or more TCI codepoints may indicate/comprise the subset of TCI states. Each TCI codepoint of the one or more TCI codepoints may indicate (or may be mapped to) respective TCI state(s) of the subset of TCI states. Each TCI codepoint of the one or more TCI codepoints may indicate/comprise (or be mapped to) one or more TCI states.

For example, the one or more TCI codepoints may be/comprise TCI codepoint 000, TCI codepoint 001, TCI codepoint 010, TCI codepoint 011, TCI codepoint 100, and TCI codepoint 101. The subset of TCI states may be/comprise TCI state 4, TCI state 9, TCI state 12, TCI state 23, TCI state 48, and TCI state 51. TCI codepoint 000 may comprise/indicate (or may be mapped to) TCI state 23. TCI codepoint 001 may comprise/indicate (or may be mapped to) TCI state 4 and TCI state 48. TCI codepoint 010 may comprise/indicate (or may be mapped to) TCI state 12. TCI codepoint 011 may comprise/indicate (or may be mapped to) TCI state 9 and TCI state 51. For example, each TCI codepoint may indicate one or more TCI states (e.g., one or more joint TCI states, one or more downlink TCI states, one or more uplink TCI states, and the like).

The activation command indicating activation of the subset of TCI states of the plurality of TCI states may comprise a plurality of fields.

A first field (e.g., Serving Cell ID) of the plurality of fields may comprise a serving cell index/identity/identifier indicating/identifying the cell. The first field may comprise the serving cell index/identity/identifier indicating/identifying the cell for which the activation command applies. If the one or more configuration parameters indicate/configure the cell in (or as a part of) a simultaneous TCI update cell list (e.g., simultaneousTCI-UpdateList1, simultaneousTCI-UpdateList2), the activation command may apply to each cell in the simultaneous TCI update cell list.

A second field (e.g., DL BWP ID) of the plurality of fields may comprise a BWP index/identity/identifier indicating/identifying the downlink BWP of the cell. The second field may comprise/indicate the BWP index/identity/identifier indicating/identifying the downlink BWP of the cell for which the activation command applies as a codepoint of a bandwidth part indicator field in a DCI.

A third field (e.g., UL BWP ID) of the plurality of fields may comprise a BWP index/identity/identifier indicating/identifying the uplink BWP of the cell. The fifth field may comprise/indicate the BWP index/identity/identifier indicating/identifying the uplink BWP of the cell for which the activation command applies as a codepoint of a bandwidth part indicator field in a DCI.

In an example, a fourth field (e.g., Pᵢ) of the plurality of fields may indicate whether each TCI codepoint has multiple TCI states or single TCI state. If the fourth field corresponding to a TCI codepoint i (e.g., Pᵢ field) is set to 1, the i^{th} TCI codepoint may include/comprise/indicate a downlink TCI state and an uplink TCI state. If the fourth field corresponding to a TCI codepoint i (e.g., Pᵢ field) is set to 0, the i^{th} TCI codepoint include/comprise/indicate only a downlink/joint TCI state or an uplink TCI state. The codepoint to which a TCI state is mapped may be determined by its ordinal position among all the TCI state ID fields.

In an example, a fourth field (e.g., F_{i,j}) of the plurality of fields may indicate whether the j-th joint/downlink TCI state is present or not for the TCI state ID fields associated with the codepoint i of the DCI Transmission Configuration Indication field, where j=1, 2. If the fourth field (e.g., F_{i,j}) field is set to 1, it may indicate the j-th joint/downlink TCI state for codepoint i is present. If fourth field (e.g., F_{i,j}) field is set to 0, it may indicate the j-th joint/downlink TCI state for codepoint i is absent. The codepoint to which a TCI state is mapped may be determined by its ordinal position among all the TCI state ID fields.

In an example, a fifth field (e.g., D/U) of the plurality of fields may indicate whether a TCI state identifier (ID) in the same octet is for a joint/downlink TCI state or an uplink TCI state. If the fifth field is set to 1, the TCI state ID in the same octet is for a joint/downlink TCI state. If the fifth field is set to 0, the TCI state ID in the same octet is for an uplink TCI state.

In an example, a fifth field (e.g., S_{i,j}) of the plurality of fields may indicate whether the j-th uplink TCI state is present or not for the TCI state ID fields associated with the codepoint i of the DCI Transmission Configuration Indication field, where j=1, 2. If the fifth field (e.g., S_{i,j}) field is set to 1, it may indicate the j-th uplink TCI state for codepoint i is present. If fifth field (e.g., S_{i,j}) field is set to 0, it may indicate the j-th uplink TCI state for codepoint i is absent. The codepoint to which a TCI state is mapped may be determined by its ordinal position among all the TCI state ID fields.

In an example, a sixth field (e.g., TCI state ID) of the plurality of fields may indicate a TCI state identified by the sixth field (e.g., TCI-StateId).

The plurality of fields may comprise one or more TCI state identifiers (e.g., TCI state ID) indicating/identifying the subset of TCI states. The plurality of TCI state identifiers may comprise the one or more TCI state identifiers. Each TCI state identifier of the one or more TCI state identifiers may indicate/identify a respective TCI state of the subset of TCI states.

The wireless device may receive a control command (e.g., Control command in FIG. 20, DCI, MAC-CE).

The control command may be, for example, a MAC-CE. The control command may be, for example, a DCI (e.g., DCI format 1_1/1_2/1_3). The control command may be, for example, a downlink control command/message (e.g., activation command).

The control command may indicate, for the cell, one or more TCI states (e.g., TCI state(s) in FIG. 20). The subset of TCI states may comprise the one or more TCI states. The plurality of TCI states in the TCI state list may comprise the one or more TCI states. The wireless device may have the one or more TCI states for the cell, for example, based on the control command indicating, for the cell, the one or more TCI states.

In an example, the control command may indicate, for downlink receptions (e.g., PDCCH, PDSCH, CSI-RS) via the cell, the one or more TCI states.

In an example, the control command may indicate, for uplink transmissions (e.g., PUCCH, PUSCH, SRS) via the cell, the one or more TCI states.

In an example, a number of the one or more TCI codepoints may be equal to one (e.g., a single TCI codepoint). The single TCI codepoint may indicate the one or more TCI states. The control command indicating the one or more TCI states may be the activation command activating the subset of TCI states, for example, based on the number of the one or more TCI codepoints being equal to one. The one or more TCI states may be the subset of TCI states, for example, based on the number of the one or more TCI codepoints being equal to one. The activation command may indicate the one or more TCI states based on the number of the one or more TCI codepoints being equal to one. The control command may be, for example, a MAC-CE.

In an example, a number of the one or more TCI codepoints may be more than one. The control command indicating the one or more TCI states may be different from the activation command activating the subset of TCI states, for example, based on the number of the one or more TCI codepoints being more than one. The wireless device may receive the control command after receiving the activation command. The control command may be, for example, a DCI (e.g., DCI format 1_1/1_2/1_3). The control command (e.g., DCI format 1_1/1_2/1_3) may comprise a TCI field indicating the one or more TCI states. A value of the TCI field may be equal to a TCI codepoint (e.g., TCI codepoint 100), of the one or more TCI codepoints, indicating (or mapped to/with) the one or more TCI states. The control command may indicate, for the TCI field, the TCI codepoint. The one or more TCI states may be mapped to the TCI codepoint. For example, when the value of the TCI field indicated TCI codepoint 000, the one or more TCI states is TCI state 23. When the value of the TCI field indicated TCI codepoint 001, the one or more TCI states are TCI state 4 and TCI state 48.

The one or more TCI states may be, for example, one or more joint TCI states.

The one or more TCI states may be, for example, one or more downlink TCI states.

The one or more TCI states may be, for example, one or more uplink TCI states.

In an example, the one or more TCI states may be one TCI state (or a single TCI state). The one or more TCI states may be a first TCI state (or a first indicated TCI state).

In an example, the one or more TCI states may be two TCI states (or two indicated TCI states). The two TCI states may comprise a first TCI state (or a first indicated TCI state) and a second TCI state (or a second indicated TCI state). The first TCI state may be different from the second TCI state.

The TCI state list (e.g., indicated by dl-OrJoint-TCIStateList or ul-TCI-StateList) may comprise the first TCI state. The TCI state list (e.g., indicated by dl-OrJoint-TCIStateList or ul-TCI-StateList) may comprise the second TCI state.

In an example, the plurality of TCI states indicated by the higher layer parameter by dl-OrJoint-TCIStateList may comprise the first TCI state. The first TCI state may be, for example, a first downlink TCI state. The first TCI state may be, for example, a first joint TCI state. In an example, the plurality of TCI states indicated by the higher layer parameter by dl-OrJoint-TCIStateList may comprise the second TCI state. The second TCI state may be, for example, a second downlink TCI state. The second TCI state may be, for example, a second joint TCI state.

In an example, the second plurality of TCI states indicated by the higher layer parameter by ul-TCI-StateList may comprise the first TCI state. The first TCI state may be, for example, a first uplink TCI state. In an example, the second plurality of TCI states indicated by the higher layer parameter by ul-TCI-StateList may comprise the second TCI state. The second TCI state may be, for example, a second uplink TCI state.

The one or more configuration parameters may comprise a first TCI state configuration of the first TCI state.

The one or more configuration parameters may indicate, for the first TCI state, a first TCI state index/identifier (e.g., tci-StateId in FIG. 19). The plurality of TCI state indexes may comprise the first TCI state index/identifier. The first TCI state may be indicated/identified by the first TCI state index/identifier. The first TCI state configuration of the first TCI state may comprise/have/indicate/provide the first TCI state index/identifier of/for the first TCI state.

The one or more configuration parameters may comprise a second TCI state configuration of the second TCI state.

The one or more configuration parameters may indicate, for the second TCI state, a second TCI state index/identifier (e.g., tci-StateId in FIG. 19). The plurality of TCI state indexes may comprise the second TCI state index/identifier. The second TCI state may be indicated/identified by the second TCI state index/identifier. The second TCI state configuration of the second TCI state may comprise/have/indicate/provide the second TCI state index/identifier of/for the second TCI state.

For example, a TCI state index may be (or may be interchangeably used with) a TCI state identity. For example, a TCI state index may be (or may be interchangeably used with) a TCI state identifier.

The one or more configuration parameters may indicate, for the first TCI state, a first reference signal (e.g., referenceSignal in FIG. 19). The first TCI state configuration of the first TCI state may comprise/have/indicate/provide a first reference signal index (e.g., ssb-Index, csi-RS-Index/NZP-CSI-RS-ResourceId, SRS-ResourceId) indicating/identifying the first reference signal.

The one or more configuration parameters may indicate, for the second TCI state, a second reference signal (e.g., referenceSignal in FIG. 19). The second TCI state configuration of the second TCI state may comprise/have/indicate/provide a second reference signal index (e.g., ssb-Index, csi-RS-Index/NZP-CSI-RS-ResourceId, SRS-ResourceId) indicating/identifying the second reference signal.

For example, a reference signal index may be (or may be interchangeably used with) a reference signal identity. For example, a reference signal index may be (or may be interchangeably used with) a reference signal identifier.

The wireless device may apply the first TCI state (e.g., the first joint TCI state or the first downlink TCI state) to a first downlink reception (e.g., PDSCH/PDCCH/CSI-RS) via the cell.

In example, applying the first TCI state to the first downlink reception may comprise receiving/performing the first downlink reception with/using a first spatial domain receiving/reception/receive filter/beam determined based on the first reference signal indicated by the first TCI state. The wireless device may determine, for the first downlink reception, the first spatial domain receiving/reception/receive filter/beam based on the first reference signal indicated by (or of) the first TCI state In an example, the wireless device may receive the first downlink reception with/using the first spatial domain receiving/reception/receive filter/beam that is the same as (or substantially same as) a spatial domain reception/receiving filter/beam used to receive the first reference signal (e.g., SSB. CSI-RS).

In example, applying the first TCI state to the first downlink reception may comprise at least one DM-RS port of the first downlink reception (e.g., PDSCH, PDCCH) is quasi co-located with the first reference signal indicated by the first TCI state. The at least one DM-RS port of the first downlink reception may be quasi co-located with the first reference signal with respect to a first quasi co-location type (e.g., QCL-Type A, QCL-Type B, QCL-Type D) indicated by the first TCI state.

In example, applying the first TCI state to the first downlink reception may comprise at least one CSI-RS port of the first downlink reception (e.g., CSI-RS, CSI-RS resource) is quasi co-located with the first reference signal indicated by the first TCI state. The at least one CSI-RS port of the first downlink reception may be quasi co-located with the first reference signal with respect to a first quasi co-location type (e.g., QCL-Type A, QCL-Type B, QCL-Type D) indicated by the first TCI state.

The wireless device may apply the first TCI state (e.g., the first joint TCI state or the first uplink TCI state) to a first uplink transmission (e.g., PUSCH/PUCCH/SRS) via the cell.

In an example, applying the first TCI state to the first uplink transmission may comprise transmitting/performing the first uplink transmission with/using a first spatial domain transmission/transmit filter/beam determined based on the first reference signal indicated by the first TCI state. The wireless device may determine, for the first uplink transmission, the first spatial domain transmission/transmit filter/beam based on the first reference signal indicated by (or of) the first TCI state In an example, the wireless device may transmit the first uplink transmission with/using the first spatial domain transmission/transmit filter/beam that is the same as (or substantially same as) a spatial domain reception/receiving filter/beam used to receive the first reference signal (e.g., SSB, CSI-RS). In an example, the wireless device may transmit the first uplink transmission with/using the first spatial domain transmission/transmit filter/beam that is the same as (or substantially same as) a spatial domain transmission/transmit filter/beam used to transmit the first reference signal (e.g., SRS).

The one or more configuration parameters may indicate, for the first TCI state, a first uplink power control set (e.g., ul-powerControl in FIG. 19). The first TCI state configuration of the first TCI state may comprise/have/indicate/provide a first uplink power control index (e.g., ul-powerControlId in FIG. 19) indicating/identifying the first uplink power control set. The first uplink power control set may indicate/comprise one or more first uplink power control parameters. The one or more first uplink power control parameters may comprise, for example, a target received power (e.g., P0). The one or more first uplink power control parameters may comprise, for example, a closed-loop index. The one or more first uplink power control parameters may comprise, for example, a pathloss compensation factor.

In an example, applying the first TCI state to the first uplink transmission may comprise transmitting/performing the first uplink transmission with/using a first transmission/transmit power determined based on the one or more first uplink power control parameters indicated by (or mapped to or associated with) the first TCI state.

For example, an uplink power control index may be (or may be interchangeably used with) an uplink power control identity. For example, an uplink power control index may be (or may be interchangeably used with) an uplink power control identifier.

The one or more configuration parameters may indicate, for the first TCI state, a first reference signal (e.g., PathlossReferenceRS-Id in FIG. 19) for pathloss estimation. The first TCI state configuration of the first TCI state may comprise/have/indicate/provide a first pathloss reference RS index (e.g., PathlossReferenceRS-Id in FIG. 19) indicating/identifying the first reference signal. The first reference signal may be a first pathloss reference signal used for pathloss estimation of uplink transmissions using/applying the first TCI state.

In an example, applying the first TCI state to the first uplink transmission may comprise transmitting/performing the first uplink transmission with/using a first transmission power determined based on the first reference signal (e.g., PathlossReferenceRS-Id in FIG. 19) indicated by (or mapped to or associated with) the first TCI state.

For example, a pathloss reference RS index may be (or may be interchangeably used with) a pathloss reference RS identity. For example, a pathloss reference RS index may be (or may be interchangeably used with) a pathloss reference RS identifier.

The wireless device may apply the second TCI state (e.g., the second joint TCI state or the second downlink TCI state) to a second downlink reception (e.g., PDSCH/PDCCH/CSI-RS) via the cell.

In example, applying the second TCI state to the second downlink reception may comprise receiving/performing the second downlink reception with/using a second spatial domain receiving/reception/receive filter/beam determined based on the second reference signal indicated by the second TCI state. The wireless device may determine, for the second downlink reception, the second spatial domain receiving/reception/receive filter/beam based on the second reference signal indicated by (or of) the second TCI state In an example, the wireless device may receive the second downlink reception with/using the second spatial domain receiving/reception/receive filter/beam that is the same as (or substantially same as) a spatial domain reception/receiving filter/beam used to receive the second reference signal (e.g., SSB, CSI-RS).

In example, applying the second TCI state to the second downlink reception may comprise at least one DM-RS port of the second downlink reception (e.g., PDSCH, PDCCH) is quasi co-located with the second reference signal indicated by the second TCI state. The at least one DM-RS port of the second downlink reception may be quasi co-located with the second reference signal with respect to a second quasi co-location type (e.g., QCL-Type A, QCL-Type B, QCL-Type D) indicated by the second TCI state.

In example, applying the second TCI state to the second downlink reception may comprise at least one CSI-RS port of the second downlink reception (e.g., CSI-RS, CSI-RS resource) is quasi co-located with the second reference signal indicated by the second TCI state. The at least one CSI-RS port of the second downlink reception may be quasi co-located with the second reference signal with respect to a second quasi co-location type (e.g., QCL-Type A, QCL-Type B, QCL-Type D) indicated by the second TCI state.

The wireless device may apply the second TCI state (e.g., the second joint TCI state or the second uplink TCI state) to a second uplink transmission (e.g., PUSCH/PUCCH/SRS) via the cell.

In an example, applying the second TCI state to the second uplink transmission may comprise transmitting/performing the second uplink transmission with/using a second spatial domain transmission/transmit filter/beam determined based on the second reference signal indicated by the second TCI state. The wireless device may determine, for the second uplink transmission, the second spatial domain transmission/transmit filter/beam based on the second reference signal indicated by (or of) the second TCI state In an example, the wireless device may transmit the second uplink transmission with/using the second spatial domain transmission/transmit filter/beam that is the same as (or substantially same as) a spatial domain reception/receiving filter/beam used to receive the second reference signal (e.g., SSB, CSI-RS). In an example, the wireless device may transmit the second uplink transmission with/using the second spatial domain transmission/transmit filter/beam that is the same as (or substantially same as) a spatial domain transmission/transmit filter/beam used to transmit the second reference signal (e.g., SRS).

The one or more configuration parameters may indicate, for the second TCI state, a second uplink power control set (e.g., ul-powerControl in FIG. 19). The second TCI state configuration of the second TCI state may comprise/have/indicate/provide a second uplink power control index (e.g., ul-powerControlId in FIG. 19) indicating/identifying the second uplink power control set. The second uplink power control set may indicate/comprise one or more second uplink power control parameters. The one or more second uplink power control parameters may comprise, for example, a target received power (e.g., P0). The one or more second uplink power control parameters may comprise, for example, a closed-loop index. The one or more second uplink power control parameters may comprise, for example, a pathloss compensation factor.

In an example, applying the second TCI state to the second uplink transmission may comprise transmitting/performing the second uplink transmission with/using a second transmission/transmit power determined based on the one or more second uplink power control parameters indicated by (or mapped to or associated with) the second TCI state.

The one or more configuration parameters may indicate, for the second TCI state, a second reference signal (e.g., PathlossReferenceRS-Id in FIG. 19) for pathloss estimation. The second TCI state configuration of the second TCI state may comprise/have/indicate/provide a second pathloss reference RS index (e.g., PathlossReferenceRS-Id in FIG. 19) indicating/identifying the second reference signal. The second reference signal may be a second pathloss reference signal used for pathloss estimation of uplink transmissions using/applying the second TCI state.

In an example, applying the second TCI state to the second uplink transmission may comprise transmitting/performing the second uplink transmission with/using a second transmission power determined based on the second reference signal (e.g., PathlossReferenceRS-Id in FIG. 19) indicated by (or mapped to or associated with) the second TCI state.

In an example, the first TCI state may be associated with a pathloss offset.

In an example, the first TCI state configuration of the first TCI state may comprise a first pathloss offset parameter (e.g., PathlossOffset, PlOffset, PathlossOffset in FIG. 19 and the like).

A value of the first pathloss offset parameter may be, for example, equal to a first pathloss offset. The first pathloss offset parameter may indicate the first pathloss offset. The first pathloss offset may be in dB. The first TCI state may be associated with the first pathloss offset. The first TCI state configuration of the first TCI state may comprise/have/indicate/provide the first pathloss offset parameter equal to the first pathloss offset.

In an example, the value of the first pathloss offset parameter may be indicated by RRC message(s). The value of the first pathloss offset parameter may be indicated by the first TCI state configuration of the first TCI state. The first TCI state configuration of the first TCI state may comprise/have/indicate/provide the first pathloss offset for the first pathloss offset parameter. The one or more configuration parameters may indicate, for the first TCI state, the first pathloss offset.

In an example, the value of the first pathloss offset parameter may be updated/indicated by a MAC-CE (e.g., Pathloss Offset Update MAC-CE, Pathloss Offset MAC-CE). The wireless device may receive the MAC-CE indicating the first pathloss offset for the first TCI state. The MAC-CE may indicate the value (or the first pathloss offset) for the first pathloss offset parameter.

The first TCI state may be associated with the first pathloss offset, for example, based on the one or more configuration parameters indicating, for the first TCI state, the first pathloss offset. The first TCI state may be associated with the first pathloss offset, for example, based on the first pathloss offset parameter being set/equal to the first pathloss offset.

The first TCI state may be associated with a pathloss offset, for example, based on the one or more configuration parameters indicating, for the first TCI state, the first pathloss offset. The first TCI state may be associated with a pathloss offset, for example, based on the first TCI state configuration of the first TCI state indicating the first pathloss offset for the first TCI state.

The first TCI state may be associated with a pathloss offset, for example, based on the first TCI state configuration of the first TCI state comprising the first pathloss offset parameter. The first TCI state may be associated with a pathloss offset, for example, based on the first pathloss offset parameter being present/configured/provided in the first TCI state configuration of the first TCI state.

In an example, the value of the first pathloss offset parameter may be equal to a non-zero value. The first pathloss offset may be equal to a non-zero value. The first TCI state may be associated with a pathloss offset, for example, based on the first TCI state configuration of the first TCI state comprising the first pathloss offset parameter set/equal to a non-zero value. The first TCI state may be associated with a pathloss offset, for example, based on the first pathloss offset parameter being set/equal to a non-zero value. The first TCI state may be associated with a pathloss offset, for example, based on the first pathloss offset of the first TCI state being equal to a non-zero value.

For example, the first pathloss offset may be equal to N₁ (e.g., −7 dB, −16 dB, 0 dB, 1 dB, and the like). The first pathloss offset value may be equal to N₂ (e.g., 0 dB, 1 dB, 2 dB, . . . , 7 dB, 15 dB, and the like). The first pathloss offset value may range from N₁ to N₂ with increments (or in steps of) x dB (e.g., x=1, or 2, 3, or 4 dB, and the like).

A pathloss offset may be (or may be interchangeably used with) a pathloss offset value.

The first TCI state (or the first TCI state configuration of the first TCI state) may comprise/indicate/have the first pathloss offset (or the first pathloss offset parameter), for example, when (or based on) the one or more configuration parameters comprise the first parameter (e.g., asymmetric-DL-sTRP-UL-mTRP, asymmetric-mTRP, asymmetric-TRP, uplink-only-TRP, DL-sTRP-UL-mTRP, asymmetric-DL-UL, enable-DL-sTRP-UL-mTRP, enable-asymmetric-DL-sTRP-UL-mTRP, enable-asymmetric-DL-UL, uplink-downlink, pathlossOffset, plOffset, pathlossOffsetIndicationDCI-1-0, pathlossOffset-PresentInDCI, and the like).

In an example, the first TCI state may not be associated with a pathloss offset.

In an example, the value of the first pathloss offset parameter may be equal to zero. The first pathloss offset may be equal to zero. The first TCI state may not be associated with a pathloss offset, for example, based on the first TCI state configuration of the first TCI state comprising the first pathloss offset parameter set/equal to zero. The first TCI state may not be associated with a pathloss offset, for example, based on the first pathloss offset parameter being set/equal to zero. The first TCI state may not be associated with a pathloss offset, for example, based on the first pathloss offset of the first TCI state being equal to zero.

In an example, the first TCI state configuration of the first TCI state may not comprise a first pathloss offset parameter (e.g., PathlossOffset, PlOffset, PathlossOffset in FIG. 19 and the like).

The first TCI state may not be associated with a pathloss offset, for example, based on the one or more configuration parameters not indicating, for the first TCI state, a pathloss offset. The first TCI state may not be associated with a pathloss offset, for example, based on the first TCI state configuration of the first TCI state not indicating a pathloss offset for the first TCI state.

The first TCI state may not be associated with a pathloss offset, for example, based on the first TCI state configuration of the first TCI state not comprising the first pathloss offset parameter. The first TCI state may not be associated with a pathloss offset, for example, based on the first pathloss offset parameter being absent (or not being present or not being configured/provided) in the first TCI state configuration of the first TCI state.

In an example, the second TCI state may be associated with a pathloss offset.

In an example, the second TCI state configuration of the second TCI state may comprise a second pathloss offset parameter (e.g., PathlossOffset, PlOffset, PathlossOffset in FIG. 19 and the like).

A value of the second pathloss offset parameter may be, for example, equal to a second pathloss offset. The second pathloss offset parameter may indicate the second pathloss offset. The second pathloss offset may be in dB. The second TCI state may be associated with the second pathloss offset. The second TCI state configuration of the second TCI state may comprise/have/indicate/provide the second pathloss offset parameter equal to the second pathloss offset.

In an example, the value of the second pathloss offset parameter may be indicated by RRC message(s). The value of the second pathloss offset parameter may be indicated by the second TCI state configuration of the second TCI state. The second TCI state configuration of the second TCI state may comprise/have/indicate/provide the second pathloss offset for the second pathloss offset parameter. The one or more configuration parameters may indicate, for the second TCI state, the second pathloss offset.

In an example, the value of the second pathloss offset parameter may be updated/indicated by a MAC-CE (e.g., Pathloss Offset Update MAC-CE, Pathloss Offset MAC-CE). The wireless device may receive the MAC-CE indicating the second pathloss offset for the second TCI state. The MAC-CE may indicate the value (or the second pathloss offset) for the second pathloss offset parameter.

The second TCI state may be associated with the second pathloss offset, for example, based on the one or more configuration parameters indicating, for the second TCI state, the second pathloss offset. The second TCI state may be associated with the second pathloss offset, for example, based on the second pathloss offset parameter being set/equal to the second pathloss offset.

The second TCI state may be associated with a pathloss offset, for example, based on the one or more configuration parameters indicating, for the second TCI state, the second pathloss offset. The second TCI state may be associated with a pathloss offset, for example, based on the second TCI state configuration of the second TCI state indicating the second pathloss offset for the second TCI state.

The second TCI state may be associated with a pathloss offset, for example, based on the second TCI state configuration of the second TCI state comprising the second pathloss offset parameter. The second TCI state may be associated with a pathloss offset, for example, based on the second pathloss offset parameter being present/configured/provided in the second TCI state configuration of the second TCI state.

In an example, the value of the second pathloss offset parameter may be equal to a non-zero value. The second pathloss offset may be equal to a non-zero value. The second TCI state may be associated with a pathloss offset, for example, based on the second TCI state configuration of the second TCI state comprising the second pathloss offset parameter set/equal to a non-zero value. The second TCI state may be associated with a pathloss offset, for example, based on the second pathloss offset parameter being set/equal to a non-zero value. The second TCI state may be associated with a pathloss offset, for example, based on the second pathloss offset of the second TCI state being equal to a non-zero value.

For example, the second pathloss offset may be equal to N₁ (e.g., −7 dB, −16 dB, 0 dB, 1 dB, and the like). The second pathloss offset value may be equal to N₂ (e.g., 0 dB, 1 dB, 2 dB, . . . , 7 dB, 15 dB, and the like). The second pathloss offset value may range from N₁ to N₂ with increments (or in steps of) x dB (e.g., x=1, or 2, 3, or 4 dB, and the like).

The second TCI state (or the second TCI state configuration of the second TCI state) may comprise/indicate/have the second pathloss offset (or the second pathloss offset parameter), for example, when (or based on) the one or more configuration parameters comprise the first parameter (e.g., asymmetric-DL-sTRP-UL-mTRP, asymmetric-mTRP, asymmetric-TRP, uplink-only-TRP, DL-sTRP-UL-mTRP, asymmetric-DL-UL, enable-DL-sTRP-UL-mTRP, enable-asymmetric-DL-sTRP-UL-mTRP, enable-asymmetric-DL-UL, uplink-downlink, pathlossOffset, plOffset, pathlossOffsetIndicationDCI-1-0, pathlossOffset-PresentInDCI, and the like).

In an example, the second TCI state may not be associated with a pathloss offset.

In an example, the value of the second pathloss offset parameter may be equal to zero. The second pathloss offset may be equal to zero. The second TCI state may not be associated with a pathloss offset, for example, based on the second TCI state configuration of the second TCI state comprising the second pathloss offset parameter set/equal to zero. The second TCI state may not be associated with a pathloss offset, for example, based on the second pathloss offset parameter being set/equal to zero. The second TCI state may not be associated with a pathloss offset, for example, based on the second pathloss offset of the second TCI state being equal to zero.

In an example, the second TCI state configuration of the second TCI state may not comprise a second pathloss offset parameter (e.g., PathlossOffset, PlOffset, PathlossOffset in FIG. 19 and the like).

The second TCI state may not be associated with a pathloss offset, for example, based on the one or more configuration parameters not indicating, for the second TCI state, a pathloss offset. The second TCI state may not be associated with a pathloss offset, for example, based on the second TCI state configuration of the second TCI state not indicating a pathloss offset for the second TCI state.

The second TCI state may not be associated with a pathloss offset, for example, based on the second TCI state configuration of the second TCI state not comprising the second pathloss offset parameter. The second TCI state may not be associated with a pathloss offset, for example, based on the second pathloss offset parameter being absent (or not being present or not being configured/provided) in the second TCI state configuration of the second TCI state.

FIG. 20 illustrates an example of applying pathloss offset for a random-access procedure as per an aspect of an embodiment of the present disclosure.

The wireless device may receive/detect, via a coreset (e.g., Coreset in FIG. 20), a PDCCH order triggering/initiating a random-access procedure. The PDCCH order (e.g., PDCCH order in FIG. 20) may trigger/initiate the random-access procedure for/via the cell.

The PDCCH order may be, for example, a DCI format 1_0.

The wireless device may initiate/trigger the random-access procedure based on receiving/detecting the PDCCH order.

The wireless device may receive, via a coreset, a PDCCH order triggering/initiating a random-access procedure.

For example, the active downlink BWP of the cell may comprise the coreset.

The random-access procedure may be, for example, a contention-free random-access procedure. The random-access procedure may be, for example, a contention-based random-access procedure.

The wireless device may transmit a PRACH transmission (or a random-access preamble) for the random-access procedure. The wireless device may transmit the PRACH transmission (or the random-access preamble) for the random-access procedure, for example, based on receiving/detecting the PDCCH order triggering/initiating the random-access procedure. The wireless device may transmit, via the cell (or the uplink BWP of the cell), the PRACH transmission. The wireless device may transmit the PRACH transmission (e.g., PRACH in FIG. 20) with/using a transmission power. The wireless device may determine/calculate/compute the transmission power based on (or using) a pathloss estimate.

At least one DM-RS of the PDCCH order may be quasi co-located with a downlink reference signal (e.g., SS/PBCH block, CSI-RS, Downlink RS in FIG. 20).

In an example, a TCI state indicated/activated for the coreset that the wireless device receives the PDCCH order may indicate/have/comprise the downlink reference signal. The wireless device may receive a control command (e.g., DCI, MAC-CE) indicating the TCI state for the coreset. The TCI state list (e.g., indicated by dl-OrJoint-TCIStateList) may comprise the TCI state. The one or more configuration parameters may comprise a TCI state configuration of the TCI state. The TCI state configuration of the TCI state may comprise/have/indicate a reference signal index (e.g., referenceSignal in FIG. 19) indicating/identifying the downlink reference signal. The one or more configuration parameters may indicate, for the TCI state (or the TCI state configuration), the downlink reference signal.

In an example, a quasi co-location assumption/property of the coreset may indicate/comprise the downlink reference signal.

At least one DM-RS antenna port of PDCCH receptions in/via the coreset may be quasi co-located with the downlink reference signal.

The PDCCH order may comprise a field (e.g., pathloss offset indicator field in FIG. 20, pathloss offset field, pathloss offset association field, and the like) with a value.

The one or more configuration parameters may indicate, for the cell, two timing advance groups (TAGs). The two TAGs may comprise a first TAG and a second TAG. The one or more configuration parameters may comprise a first TAG identifier/index/identity (e.g., tag-Id) indicating/identifying the first TAG. The one or more configuration parameters may comprise a second TAG identifier/index/identity (e.g., tag2-Id) indicating/identifying the second TAG.

The one or more configuration parameters may comprise a parameter (e.g., pathlossOffsetIndicationDCI-1-0, pathlossOffset-PresentInDCI) indicating whether the field (e.g., pathloss offset indicator field in FIG. 20, pathloss offset field, pathloss offset association field, and the like) is present or absent in a DCI format (e.g., DCI format 1_0). When the parameter is absent in the one or more configuration parameters, the wireless device may consider/assume/determine the field to be absent/disabled in the DCI format. When the parameter is present/enabled in the one or more configuration parameters, the wireless device may consider/assume/determine the field to be present/enabled in the DCI format.

In an example, the parameter may be per BWP. The one or more configuration parameters may indicate, for each downlink BWP of the cell, the parameter. The one or more configuration parameters may indicate, for a first downlink BWP of the cell, the parameter with a first value. The one or more configuration parameters may indicate, for a second downlink BWP of the cell, the parameter with a second value. In an example, the one or more configuration parameters may not indicate, for a third downlink BWP of the cell, the parameter.

In an example, the parameter may be per cell. The one or more configuration parameters may indicate, for the cell, the parameter. The parameter may be applicable for each downlink BWP of the cell based on the parameter being per cell. The one or more configuration parameters may not indicate, for any downlink BWP of the cell, the parameter based on the parameter being for the cell.

The one or more configuration parameters may indicate, for at least one TCI state among the plurality of TCI states in the TCI state list, a pathloss offset. The one or more configuration parameters may indicate/comprise, for the at least one TCI state among the plurality of TCI states in the TCI state list, a pathloss offset parameter (e.g., PathlossOffset, PlOffset, PathlossOffset in FIG. 19 and the like). TCI state configuration of the at least one TCI state among the plurality of TCI states in the TCI state list may comprise/indicate/contain a pathloss offset parameter. The one or more configuration parameters may comprise the TCI state configuration.

The PDCCH order may comprise the field (e.g., pathloss offset indicator field in FIG. 20, pathloss offset field, pathloss offset association field, and the like), for example, based on the one or more configuration parameters indicating, for the cell, the two TAGs. The PDCCH order may comprise the field, for example, based on the one or more configuration parameters comprising the second TAG identifier/index/identity (e.g., tag2-Id). A size of the field may be, for example, 1 bit based on the one or more configuration parameters comprising the second TAG identifier/index/identity. A size of the field may be, for example, 1 bit based on the one or more configuration parameters indicating, for the cell, the two TAGs.

The PDCCH order may not comprise the field (e.g., pathloss offset indicator field in FIG. 20, pathloss offset field, pathloss offset association field, and the like), for example, based on the one or more configuration parameters not indicating, for the cell, the two TAGs. The PDCCH order may not comprise the field, for example, based on the one or more configuration parameters indicating, for the cell, one/single TAG. The PDCCH order may not comprise the field, for example, based on the one or more configuration parameters not comprising the second TAG identifier/index/identity (e.g., tag2-Id). A size of the field may be, for example, 0 bit based on the one or more configuration parameters not comprising the second TAG identifier/index/identity (e.g., tag2-Id). A size of the field may be, for example, 0 bit based on the one or more configuration parameters not indicating, for the cell, the two TAGs.

The PDCCH order may comprise the field (e.g., pathloss offset indicator field in FIG. 20, pathloss offset field, pathloss offset association field, and the like), for example, based on the one or more configuration parameters comprising the parameter (e.g., pathlossOffsetIndicationDCI-1-0, pathlossOffset-PresentInDCI). The PDCCH order may comprise the field, for example, based on the parameter being present/enabled (or being set/configured to be enabled) in the one or more configuration parameters. A size of the field may be, for example, 1 bit based on the one or more configuration parameters comprising the parameter. A size of the field may be, for example, 1 bit based on the parameter being present/enabled (or being set/configured to be enabled).

The PDCCH order may not comprise the field (e.g., pathloss offset indicator field in FIG. 20, pathloss offset field, pathloss offset association field, and the like), for example, based on the one or more configuration parameters not comprising the parameter (e.g., pathlossOffsetIndicationDCI-1-0, pathlossOffset-PresentInDCI). The PDCCH order may not comprise the field, for example, based on the parameter being absent/disabled (or not being set/configured to be enabled or being set/configured to be disabled) in the one or more configuration parameters. A size of the field may be, for example, 0 bit based on the one or more configuration parameters not comprising the parameter. A size of the field may be, for example, 0 bit based on the parameter being absent/disabled (or not being set/configured to be enabled or being set/configured to be disabled).

The PDCCH order may comprise the field (e.g., pathloss offset indicator field in FIG. 20, pathloss offset field, pathloss offset association field, and the like), for example, based on the one or more configuration parameters indicating, for the at least one TCI state among the plurality of TCI states in the TCI state list, a pathloss offset. The PDCCH order may comprise the field, for example, based on the one or more configuration parameters indicating/comprising, for the at least one TCI state, a pathloss offset parameter (e.g., PathlossOffset, PlOffset, PathlossOffset in FIG. 19 and the like). The PDCCH order may comprise the field, for example, based on the TCI state configuration of the at least one TCI state comprising/indicating/containing the pathloss offset parameter. A size of the field may be, for example, 1 bit based on the one or more configuration parameters indicating, for the at least one TCI state among the plurality of TCI states in the TCI state list, a pathloss offset. A size of the field may be, for example, 1 bit based on the one or more configuration parameters indicating/comprising, for the at least one TCI state, the pathloss offset parameter. A size of the field may be, for example, 1 bit based on the TCI state configuration of the at least one TCI state comprising/indicating/containing the pathloss offset parameter.

The PDCCH order may not comprise the field (e.g., pathloss offset indicator field in FIG. 20, pathloss offset field, pathloss offset association field, and the like), for example, based on the one or more configuration parameters not indicating, for the at least one TCI state among the plurality of TCI states in the TCI state list, a pathloss offset. The PDCCH order may not comprise the field, for example, based on the one or more configuration parameters not indicating/comprising, for the at least one TCI state, a pathloss offset parameter (e.g., PathlossOffset, PlOffset, PathlossOffset in FIG. 19 and the like). The PDCCH order may not comprise the field, for example, based on the TCI state configuration of the at least one TCI state not comprising/indicating/containing the pathloss offset parameter. A size of the field may be, for example, 0 bit based on the one or more configuration parameters not indicating, for the at least one TCI state among the plurality of TCI states in the TCI state list, a pathloss offset. A size of the field may be, for example, 0 bit based on the one or more configuration parameters not indicating/comprising, for the at least one TCI state, the pathloss offset parameter. A size of the field may be, for example, 0 bit based on the TCI state configuration of the at least one TCI state not comprising/indicating/containing the pathloss offset parameter.

In an example, the field may be absent in the PDCCH order when the size of the field is 0 bit. The PDCCH order may not comprise the field when the size of the field is 0 bit.

In an example, the one or more configuration parameters may not comprise a parameter (e.g., SSB-MTC-AdditionalPCI) indicating a physical cell identifier/index (PCI) of an (additional) SSB different from a PCI of the cell (e.g., a serving cell).

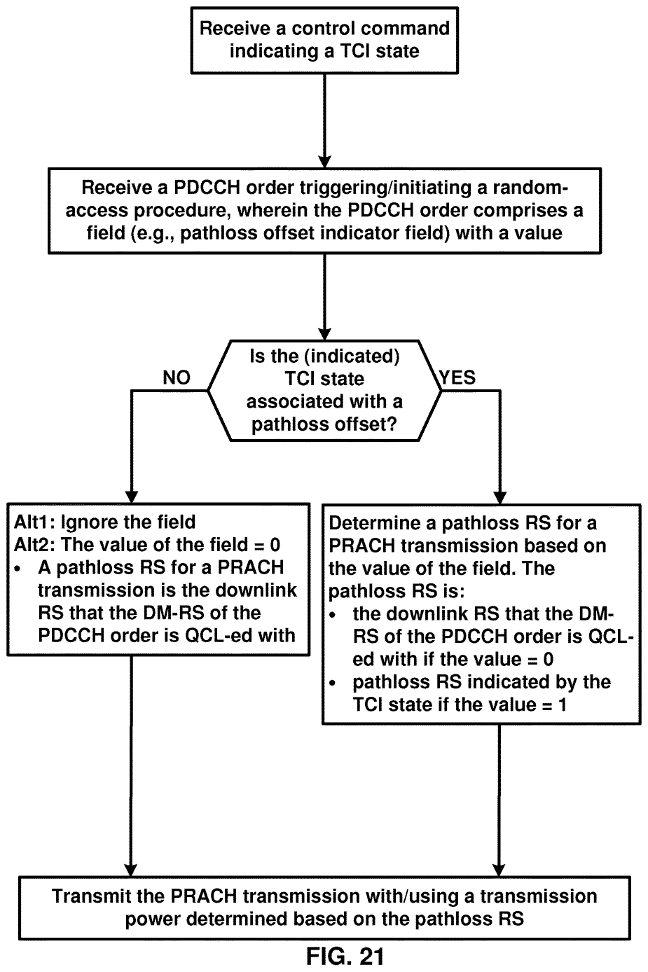

FIG. 21 illustrates an example flow chart of applying pathloss offset for a random-access procedure as per an aspect of an embodiment of the present disclosure.

In an example, the one or more TCI states may be one TCI state (or a single TCI state). The one or more TCI states may be the first TCI state (or the first indicated TCI state).

In an example, the first TCI state may not be associated with a pathloss offset.

The wireless device may ignore the field in the PDCCH order. By ignoring the field, the wireless device may not use the field (or the value of the field) for the PRACH transmission. By ignoring the field, the wireless device may not use the field (or the value of the field) to determine/calculate/compute the transmission power for/of the PRACH transmission. By ignoring the field, the wireless device may not use the field (or the value of the field) to determine/calculate/compute the pathloss estimate of/for the PRACH transmission.

The wireless device may ignore the field in the PDCCH order, for example, based on the first TCI state not being associated with a pathloss offset.

The value of the field may be set/equal to a first value (e.g., 0), for example, based on the first TCI state not being associated with a pathloss offset. The base station may set the value of the field to the first value (e.g., 0), for example, based on the first TCI state not being associated with a pathloss offset. The wireless device may expect the value of the field, in the PDCCH order, set/equal to the first value (e.g., 0), for example, based on the first TCI state not being associated with a pathloss offset.

The value of the field may not be set/equal to a second value (e.g., 1), for example, based on the first TCI state not being associated with a pathloss offset. The base station may not set the value of the field to the second value (e.g., 1), for example, based on the first TCI state not being associated with a pathloss offset. The wireless device may not expect the value of the field, in the PDCCH order, set/equal to the second value (e.g., 1), for example, based on the first TCI state not being associated with a pathloss offset.

The wireless device may determine/assume the value of the field as a first value (e.g., 0), for example, based on the first TCI state not being associated with a pathloss offset.

The wireless device may determine/calculate/compute, based on (or using) the downlink reference signal that the at least one DM-RS of the PDCCH order is quasi co-located with, the pathloss estimate used for calculation of the transmission power of/for the PRACH transmission. A pathloss reference signal for the PRACH transmission may be the downlink reference signal that the at least one DM-RS of the PDCCH order is quasi co-located with.

The wireless device may determine/calculate/compute, based on (or using) the downlink reference signal that the at least one DM-RS of the PDCCH order is quasi co-located with, the pathloss estimate, for example, based on ignoring the field in the PDCCH order.

The wireless device may determine/calculate/compute, based on (or using) the downlink reference signal that the at least one DM-RS of the PDCCH order is quasi co-located with, the pathloss estimate, for example, based on the value of the field being set/equal to the first value (e.g., 0).

The wireless device may determine/calculate/compute, based on (or using) the downlink reference signal that the at least one DM-RS of the PDCCH order is quasi co-located with, the pathloss estimate, for example, based on determining/assuming the value of the field as the first value (e.g., 0).

In an example, the first TCI state may be associated with a pathloss offset.

The first TCI state may be associated with the first pathloss offset.

In an example, the value of the field may be equal/set to the first value (e.g., 0).

The wireless device may determine/calculate/compute, based on (or using) the downlink reference signal that the at least one DM-RS of the PDCCH order is quasi co-located with, the pathloss estimate used for calculation of the transmission power of/for the PRACH transmission. A pathloss reference signal for the PRACH transmission may be the downlink reference signal that the at least one DM-RS of the PDCCH order is quasi co-located with. The wireless device may determine/calculate/compute, based on (or using) the downlink reference signal that the at least one DM-RS of the PDCCH order is quasi co-located with, the pathloss estimate, for example, based on the value of the field being set/equal to the first value (e.g., 0). The wireless device may not use the first pathloss offset associated with the first TCI state for/in determination/calculation of the pathloss estimate. The wireless device may not determine, for the PRACH transmission, the pathloss estimate based on (or using) the first pathloss offset, for example, based on the value of the field being set/equal to the first value (e.g., 0). When the value of the field is set/equal to the first value (e.g., 0), based on the single TCI state being indicated for/to the wireless device (or the cell), the wireless device may determine/calculate/compute, based on (or using) the downlink reference signal that the at least one DM-RS of the PDCCH order is quasi co-located with, the pathloss estimate.

In an example, the value of the field may be equal/set to the second value (e.g., 1).

The wireless device may determine/calculate/compute, based on (or using) the first reference signal (or the first pathloss reference signal indicated by PathlossReferenceRS-Id in FIG. 19) indicated by (or associated with) the first TCI state, the pathloss estimate used for calculation of the transmission power of/for the PRACH transmission. A pathloss reference signal for the PRACH transmission may be the first reference signal (or the first pathloss reference signal) associated with the first TCI state. The wireless device may determine/calculate/compute, based on (or using) the first reference signal (or the first pathloss reference signal), the pathloss estimate, for example, based on the value of the field being set/equal to the second value (e.g., 1). The wireless device may use the first pathloss offset associated with the first TCI state for/in determination/calculation of the pathloss estimate. The wireless device may determine, for the PRACH transmission, the pathloss estimate based on (or using) the first pathloss offset, for example, based on the value of the field being set/equal to the second value (e.g., 1). When the value of the field is set/equal to the second value (e.g., 1), based on the single TCI state being indicated for/to the wireless device (or the cell), the wireless device may determine/calculate/compute, based on (or using) the first reference signal, the pathloss estimate.

The wireless device may determine/calculate/compute, for the PRACH transmission (or for determination/calculation of the transmission power of the PRACH transmission), a downlink pathloss estimate based on (or using) the first reference signal (or the first pathloss reference signal indicated by PathlossReferenceRS-Id in FIG. 19) indicated by (or associated with) the first TCI state. The wireless device may determine/calculate/compute, for the PRACH transmission (or for determination/calculation of the transmission power of the PRACH transmission), the downlink pathloss estimate based on (or using) the first reference signal (or the first pathloss reference signal) associated with the first TCI state, for example, based on the value of the field being set/equal to the second value (e.g., 1).

The wireless device may determine/calculate/compute the downlink pathloss estimate based on determining/measuring/assessing a radio link quality (e.g., RSRP, L3-RSRP, higher layer filtered RSRP, L1-RSRP) of the first reference signal (or the first pathloss reference signal) associated with the first TCI state. The wireless device may determine/calculate/compute the downlink pathloss estimate based on a higher layer parameter ss-PBCH-BlockPower corresponding to (or associated with) the first reference signal (or the first pathloss reference signal) associated with the first TCI state. For example, the one or more configuration parameters may indicate, for the first reference signal (or the first pathloss reference signal) associated with the first TCI state, the higher layer parameter ss-PBCH-BlockPower. For example, the one or more configuration parameters may indicate, for an SS/PBCH block that the first reference signal is quasi co-located with, the higher layer parameter ss-PBCH-BlockPower.

The wireless device may determine, for the PRACH transmission, the pathloss estimate based on (or using) both the downlink pathloss estimate of the the first reference signal (or the first pathloss reference signal) associated with the first TCI state and the first pathloss offset, for example, based on (or when) the value of the field being set/equal to the second value (e.g., 1). The wireless device may use both the downlink pathloss estimate of the first reference signal (or the first pathloss reference signal) associated with the first TCI state and the first pathloss offset to determine the pathloss estimate for the PRACH transmission, for example, based on (or when) the value of the field being set/equal to the second value (e.g., 1).

In an example, the wireless device may determine, for the PRACH transmission, the pathloss estimate based on a summation of the downlink pathloss estimate of the first reference signal (or the first pathloss reference signal) associated with the first TCI state and the first pathloss offset. The pathloss estimate may be, for example, equal to the summation of the downlink pathloss estimate of the first reference signal and the first pathloss offset. In an example, the wireless device may determine, for the PRACH transmission, the pathloss estimate based on a subtraction of the first pathloss offset from the downlink pathloss estimate of the first reference signal. The pathloss estimate may be, for example, equal to the downlink pathloss estimate of the first reference signal minus the first pathloss offset.

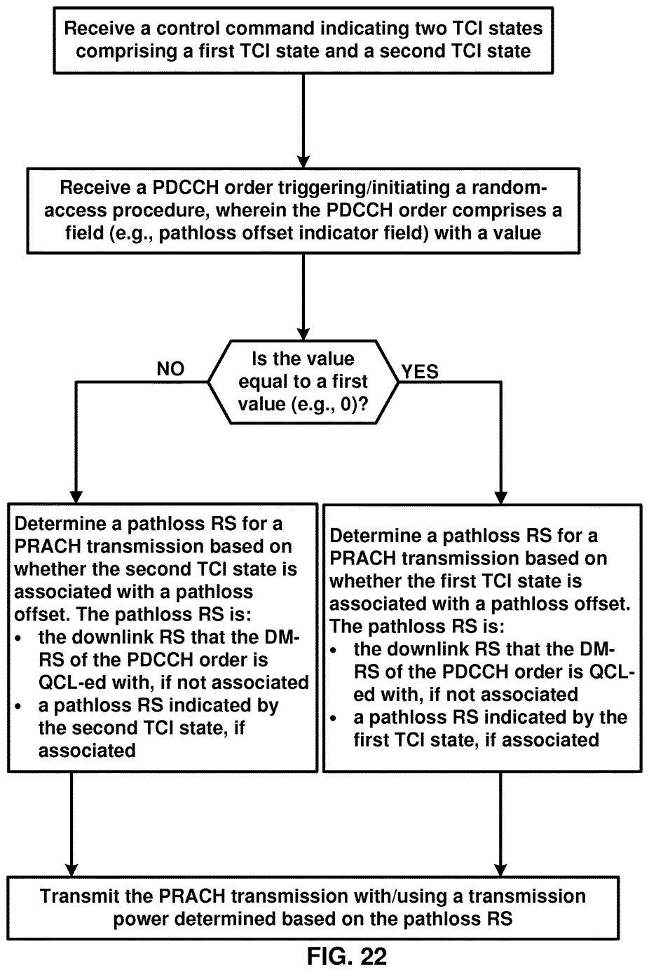

FIG. 22 illustrates an example flow chart of applying pathloss offset for a random-access procedure as per an aspect of an embodiment of the present disclosure.

In an example, the one or more TCI states may be two TCI states. The two TCI states may comprise the first TCI state (or the first indicated TCI state) and the second TCI state (or the second indicated TCI state).

In an example, the two TCI states may not be associated with a pathloss offset. Each/any TCI state of the two TCI states may not be associated with a pathloss offset. The first TCI state may not be associated with a pathloss offset. The second TCI state may not be associated with a pathloss offset.

The wireless device may ignore the field in the PDCCH order. The wireless device may ignore the field in the PDCCH order, for example, based on both the first TCI state and the second TCI state not being associated with a pathloss offset. The wireless device may ignore the field in the PDCCH order, for example, based on each/any TCI state of the two TCI states not being associated with a pathloss offset. The wireless device may ignore the field in the PDCCH order, for example, based on the two TCI states not being associated with a pathloss offset.

The field (e.g., pathloss offset indicator field) may indicate a pathloss reference signal for the PRACH transmission. The field may indicate a pathloss reference signal for the PRACH transmission, for example, based on both the first TCI state and the second TCI state not being associated with a pathloss offset. The field may indicate a pathloss reference signal for the PRACH transmission, for example, based on each/any TCI state of the two TCI states not being associated with a pathloss offset. The field may indicate a pathloss reference signal for the PRACH transmission, for example, based on the two TCI states not being associated with a pathloss offset.

In an example, the value of the field may be equal/set to the first value (e.g., 0).

The pathloss reference signal indicated by the field for the PRACH transmission may be the downlink reference signal that the at least one DM-RS of the PDCCH order is quasi co-located with, for example, based on value of the field being equal/set to the first value (e.g., 0). The wireless device may determine/calculate/compute, based on (or using) the downlink reference signal that the at least one DM-RS of the PDCCH order is quasi co-located with, the pathloss estimate used for calculation of the transmission power of/for the PRACH transmission.

In an example, the value of the field may be equal/set to the second value (e.g., 1) The PDCCH order may comprise an SS/PBCH index field. The SS/PBCH index field may indicate/identify an SS/PBCH block. The pathloss reference signal indicated by the field for the PRACH transmission may be the SS/PBCH block indicated/identified by the SS/PBCH index field in the PDCCH order, for example, based on the value of the field being equal/set to the second value (e.g., 1). The wireless device may determine/calculate/compute, based on (or using) the SS/PBCH block, the pathloss estimate used for calculation of the transmission power of/for the PRACH transmission.

In an example, at least one TCI state of the two TCI states may be associated with a pathloss offset.

In an example, the first TCI state may be associated with a pathloss offset. The second TCI state may not be associated with a pathloss offset. The at least one TCI state may be/comprise the first TCI state. The at least one TCI state may not comprise the second TCI state.

In an example, the first TCI state may not be associated with a pathloss offset. The second TCI state may be associated with a pathloss offset. The at least one TCI state may be/comprise the second TCI state. The at least one TCI state may not comprise the first TCI state.

In an example, the first TCI state may be associated with a pathloss offset. The second TCI state may be associated with a pathloss offset. Each TCI state of the two TCI states may be associated with a pathloss offset. The at least one TCI state may be/comprise the first TCI state and the second TCI state.

In an example, the value of the field may be equal/set to the first value (e.g., 0).

In an example, the first TCI state may be associated with a pathloss offset.

The first TCI state may be associated with the first pathloss offset. The at least one TCI state may comprise the first TCI state.

The wireless device may determine/calculate/compute, based on (or using) the first reference signal (or the first pathloss reference signal indicated by PathlossReferenceRS-Id in FIG. 19) indicated by (or associated with) the first TCI state, the pathloss estimate used for calculation of the transmission power of/for the PRACH transmission. A pathloss reference signal for the PRACH transmission may be the first reference signal (or the first pathloss reference signal) associated with the first TCI state. The wireless device may determine/calculate/compute, based on (or using) the first reference signal (or the first pathloss reference signal), the pathloss estimate, for example, based on the value of the field being set/equal to the first value (e.g., 0). The wireless device may determine/calculate/compute, based on (or using) the first reference signal (or the first pathloss reference signal), the pathloss estimate, for example, based on the first TCI state being associated with a pathloss offset. The wireless device may use the first pathloss offset associated with the first TCI state for/in determination/calculation of the pathloss estimate. The wireless device may determine, for the PRACH transmission, the pathloss estimate based on (or using) the first pathloss offset of the first TCI state, for example, based on the value of the field being set/equal to the first value (e.g., 0). The wireless device may determine, for the PRACH transmission, the pathloss estimate based on (or using) the first pathloss offset of the first TCI state, for example, based on the first TCI state being associated with a pathloss offset. When the value of the field is set/equal to the first value (e.g., 0) and the first TCI state is associated with a pathloss offset, based on the two TCI states being indicated for/to the wireless device (or the cell), the wireless device may determine/calculate/compute, based on (or using) the first reference signal associated with the first TCI state, the pathloss estimate.

The wireless device may determine/calculate/compute, for the PRACH transmission (or for determination/calculation of the transmission power of the PRACH transmission), a downlink pathloss estimate based on (or using) the first reference signal (or the first pathloss reference signal indicated by PathlossReferenceRS-Id in FIG. 19) indicated by (or associated with) the first TCI state. The wireless device may determine/calculate/compute, for the PRACH transmission (or for determination/calculation of the transmission power of the PRACH transmission), the downlink pathloss estimate based on (or using) the first reference signal (or the first pathloss reference signal) associated with the first TCI state, for example, based on the value of the field being set/equal to the first value (e.g., 0). The wireless device may determine/calculate/compute, for the PRACH transmission (or for determination/calculation of the transmission power of the PRACH transmission), the downlink pathloss estimate based on (or using) the first reference signal (or the first pathloss reference signal) associated with the first TCI state, for example, based on the first TCI state being associated with a pathloss offset.

The wireless device may determine, for the PRACH transmission, the pathloss estimate based on (or using) both the downlink pathloss estimate of the the first reference signal (or the first pathloss reference signal) associated with the first TCI state and the first pathloss offset, for example, based on (or when) the value of the field being set/equal to the first value (e.g., 0). The wireless device may use both the downlink pathloss estimate of the first reference signal (or the first pathloss reference signal) associated with the first TCI state and the first pathloss offset to determine the pathloss estimate for the PRACH transmission, for example, based on (or when) the value of the field being set/equal to the first value (e.g., 0).

The wireless device may determine, for the PRACH transmission, the pathloss estimate based on (or using) both the downlink pathloss estimate of the the first reference signal (or the first pathloss reference signal) associated with the first TCI state and the first pathloss offset, for example, based on (or when) the first TCI state being associated with a pathloss offset. The wireless device may use both the downlink pathloss estimate of the first reference signal (or the first pathloss reference signal) associated with the first TCI state and the first pathloss offset to determine the pathloss estimate for the PRACH transmission, for example, based on (or when) the first TCI state being associated with a pathloss offset.

The wireless device may determine, for the PRACH transmission, the pathloss estimate based on (or using) the downlink pathloss estimate of the the first reference signal (or the first pathloss reference signal) associated with the first TCI state, for example, based on (or when) the value of the field being set/equal to the first value (e.g., 0) and the first TCI state being associated with a pathloss offset. The wireless device may use the downlink pathloss estimate of the first reference signal (or the first pathloss reference signal) associated with the first TCI state to determine the pathloss estimate for the PRACH transmission, for example, based on (or when) the value of the field being set/equal to the first value (e.g., 0) and the first TCI state being associated with a pathloss offset.

When the value of the field is set/equal to the first value (e.g., 0), the wireless device may determine, for the PRACH transmission, the pathloss estimate based on (or using) the downlink pathloss estimate of the the first reference signal (or the first pathloss reference signal) associated with the first TCI state, for example, based on the first TCI state being associated with a pathloss offset. When the value of the field is set/equal to the first value (e.g., 0), the wireless device may use the downlink pathloss estimate of the first reference signal (or the first pathloss reference signal) associated with the first TCI state to determine the pathloss estimate for the PRACH transmission, for example, based on the first TCI state being associated with a pathloss offset.

In an example, the wireless device may determine, for the PRACH transmission, the pathloss estimate based on a summation of the downlink pathloss estimate of the first reference signal (or the first pathloss reference signal) associated with the first TCI state and the first pathloss offset. The pathloss estimate may be, for example, equal to the summation of the downlink pathloss estimate of the first reference signal and the first pathloss offset. In an example, the wireless device may determine, for the PRACH transmission, the pathloss estimate based on a subtraction of the first pathloss offset from the downlink pathloss estimate of the first reference signal. The pathloss estimate may be, for example, equal to the downlink pathloss estimate of the first reference signal minus the first pathloss offset.

The first TCI state may not be associated with a pathloss offset. The at least one TCI state may not comprise the first TCI state.

The wireless device may determine/calculate/compute, based on (or using) the downlink reference signal that the at least one DM-RS of the PDCCH order is quasi co-located with, the pathloss estimate used for calculation of the transmission power of/for the PRACH transmission. A pathloss reference signal for the PRACH transmission may be the downlink reference signal that the at least one DM-RS of the PDCCH order is quasi co-located with. When the value of the field is set/equal to the first value (e.g., 0), the wireless device may determine/calculate/compute, based on (or using) the downlink reference signal that the at least one DM-RS of the PDCCH order is quasi co-located with, the pathloss estimate, for example, based on the first TCI state not being associated with a pathloss offset. When the value of the field is set/equal to the first value (e.g., 0) and the first TCI state is not associated with a pathloss offset, based on the two TCI states being indicated for/to the wireless device (or the cell), the wireless device may determine/calculate/compute, based on (or using) the downlink reference signal that the at least one DM-RS of the PDCCH order is quasi co-located with, the pathloss estimate.

The wireless device may determine, for the PRACH transmission, the pathloss estimate based on (or using) the downlink reference signal that the at least one DM-RS of the PDCCH order is quasi co-located with, for example, based on (or when) the first TCI state not being associated with a pathloss offset.

When the value of the field is set/equal to the first value (e.g., 0), the wireless device may determine, for the PRACH transmission, the pathloss estimate based on (or using) the downlink reference signal that the at least one DM-RS of the PDCCH order is quasi co-located with, for example, based on the first TCI state not being associated with a pathloss offset.

The wireless device may determine, for the PRACH transmission, the pathloss estimate based on (or using) the downlink reference signal that the at least one DM-RS of the PDCCH order is quasi co-located with, for example, based on (or when) the value of the field being set/equal to the first value (e.g., 0) and the first TCI state not being associated with a pathloss offset.

In an example, the value of the field may be equal/set to the second value (e.g., 1).

In an example, the second TCI state may be associated with a pathloss offset.

The second TCI state may be associated with the second pathloss offset. The at least one TCI state may comprise the second TCI state.

The wireless device may determine/calculate/compute, based on (or using) the second reference signal (or the second pathloss reference signal indicated by PathlossReferenceRS-Id in FIG. 19) indicated by (or associated with) the second TCI state, the pathloss estimate used for calculation of the transmission power of/for the PRACH transmission. A pathloss reference signal for the PRACH transmission may be the second reference signal (or the second pathloss reference signal) associated with the second TCI state. The wireless device may determine/calculate/compute, based on (or using) the second reference signal (or the second pathloss reference signal), the pathloss estimate, for example, based on the value of the field being set/equal to the second value (e.g., 1). The wireless device may determine/calculate/compute, based on (or using) the second reference signal (or the second pathloss reference signal), the pathloss estimate, for example, based on the second TCI state being associated with a pathloss offset. The wireless device may use the second pathloss offset associated with the second TCI state for/in determination/calculation of the pathloss estimate. The wireless device may determine, for the PRACH transmission, the pathloss estimate based on (or using) the second pathloss offset associated with the second TCI state, for example, based on the value of the field being set/equal to the second value (e.g., 1). The wireless device may determine, for the PRACH transmission, the pathloss estimate based on (or using) the second pathloss offset associated with the second TCI state, for example, based on the second TCI state being associated with a pathloss offset. When the value of the field is set/equal to the second value (e.g., 1) and the second TCI state is associated with a pathloss offset, based on the two TCI states being indicated for/to the wireless device (or the cell), the wireless device may determine/calculate/compute, based on (or using) the second reference signal associated with the second TCI state, the pathloss estimate.

The wireless device may determine/calculate/compute, for the PRACH transmission (or for determination/calculation of the transmission power of the PRACH transmission), a downlink pathloss estimate based on (or using) the second reference signal (or the second pathloss reference signal indicated by PathlossReferenceRS-Id in FIG. 19) indicated by (or associated with) the second TCI state. The wireless device may determine/calculate/compute, for the PRACH transmission (or for determination/calculation of the transmission power of the PRACH transmission), the downlink pathloss estimate based on (or using) the second reference signal (or the second pathloss reference signal) associated with the second TCI state, for example, based on the value of the field being set/equal to the second value (e.g., 1). The wireless device may determine/calculate/compute, for the PRACH transmission (or for determination/calculation of the transmission power of the PRACH transmission), the downlink pathloss estimate based on (or using) the second reference signal (or the second pathloss reference signal) associated with the second TCI state, for example, based on the second TCI state being associated with a pathloss offset.

The wireless device may determine, for the PRACH transmission, the pathloss estimate based on (or using) both the downlink pathloss estimate of the the second reference signal (or the second pathloss reference signal) associated with the second TCI state and the second pathloss offset, for example, based on (or when) the value of the field being set/equal to the second value (e.g., 1). The wireless device may use both the downlink pathloss estimate of the second reference signal (or the second pathloss reference signal) associated with the second TCI state and the second pathloss offset to determine the pathloss estimate for the PRACH transmission, for example, based on (or when) the value of the field being set/equal to the second value (e.g., 1).

The wireless device may determine, for the PRACH transmission, the pathloss estimate based on (or using) both the downlink pathloss estimate of the the second reference signal (or the second pathloss reference signal) associated with the second TCI state and the second pathloss offset, for example, based on (or when) the second TCI state being associated with a pathloss offset. The wireless device may use both the downlink pathloss estimate of the second reference signal (or the second pathloss reference signal) associated with the second TCI state and the second pathloss offset to determine the pathloss estimate for the PRACH transmission, for example, based on (or when) the second TCI state being associated with a pathloss offset.

The wireless device may determine, for the PRACH transmission, the pathloss estimate based on (or using) the downlink pathloss estimate of the the second reference signal (or the second pathloss reference signal) associated with the second TCI state, for example, based on (or when) the value of the field being set/equal to the second value (e.g., 1) and the second TCI state being associated with a pathloss offset. The wireless device may use the downlink pathloss estimate of the second reference signal (or the second pathloss reference signal) associated with the second TCI state to determine the pathloss estimate for the PRACH transmission, for example, based on (or when) the value of the field being set/equal to the second value (e.g., 1) and the second TCI state being associated with a pathloss offset.

When the value of the field is set/equal to the second value (e.g., 1), the wireless device may determine, for the PRACH transmission, the pathloss estimate based on (or using) the downlink pathloss estimate of the the second reference signal (or the second pathloss reference signal) associated with the second TCI state, for example, based on the second TCI state being associated with a pathloss offset. When the value of the field is set/equal to the second value (e.g., 1), the wireless device may use the downlink pathloss estimate of the second reference signal (or the second pathloss reference signal) associated with the second TCI state to determine the pathloss estimate for the PRACH transmission, for example, based on the second TCI state being associated with a pathloss offset.

In an example, the wireless device may determine, for the PRACH transmission, the pathloss estimate based on a summation of the downlink pathloss estimate of the second reference signal (or the second pathloss reference signal) associated with the second TCI state and the second pathloss offset. The pathloss estimate may be, for example, equal to the summation of the downlink pathloss estimate of the second reference signal and the second pathloss offset. In an example, the wireless device may determine, for the PRACH transmission, the pathloss estimate based on a subtraction of the second pathloss offset from the downlink pathloss estimate of the second reference signal. The pathloss estimate may be, for example, equal to the downlink pathloss estimate of the second reference signal minus the second pathloss offset.

The second TCI state may not be associated with a pathloss offset. The at least one TCI state may not comprise the second TCI state.

The wireless device may determine/calculate/compute, based on (or using) the downlink reference signal that the at least one DM-RS of the PDCCH order is quasi co-located with, the pathloss estimate used for calculation of the transmission power of/for the PRACH transmission. A pathloss reference signal for the PRACH transmission may be the downlink reference signal that the at least one DM-RS of the PDCCH order is quasi co-located with. When the value of the field is set/equal to the second value (e.g., 1), the wireless device may determine/calculate/compute, based on (or using) the downlink reference signal that the at least one DM-RS of the PDCCH order is quasi co-located with, the pathloss estimate, for example, based on the second TCI state not being associated with a pathloss offset. When the value of the field is set/equal to the second value (e.g., 1) and the second TCI state is not associated with a pathloss offset, based on the two TCI states being indicated for/to the wireless device (or the cell), the wireless device may determine/calculate/compute, based on (or using) the downlink reference signal that the at least one DM-RS of the PDCCH order is quasi co-located with, the pathloss estimate.

The wireless device may determine, for the PRACH transmission, the pathloss estimate based on (or using) the downlink reference signal that the at least one DM-RS of the PDCCH order is quasi co-located with, for example, based on (or when) the second TCI state not being associated with a pathloss offset.

When the value of the field is set/equal to the second value (e.g., 1), the wireless device may determine, for the PRACH transmission, the pathloss estimate based on (or using) the downlink reference signal that the at least one DM-RS of the PDCCH order is quasi co-located with, for example, based on the second TCI state not being associated with a pathloss offset.

The wireless device may determine, for the PRACH transmission, the pathloss estimate based on (or using) the downlink reference signal that the at least one DM-RS of the PDCCH order is quasi co-located with, for example, based on (or when) the value of the field being set/equal to the second value (e.g., 1) and the second TCI state not being associated with a pathloss offset.

The field (e.g., pathloss offset indicator field in FIG. 20, pathloss offset field, pathloss offset association field, and the like) may be, for example, different from a PRACH association indicator field. In an example, the PDCCH order may comprise the field and may not comprise the PRACH association indicator field. In an example, the PDCCH order may comprise both the field and the PRACH association indicator field.

In an example, “when” and “based on” be interchangeably used with). For example, “A may occur based on B being satisfied”. This may be replaced with “A may occur when B is satisfied”. For example, “when a wireless device triggers A, the wireless device transmits B”. This may be replaced with “a wireless device transmits B based on triggering A”.

When the one or more configuration parameters indicate, for at least one TCI state among the plurality of TCI states in the TCI state list, a pathloss offset and the control command (e.g., Control command in FIG. 20, DCI, MAC-CE) indicates two TCI states for the cell, both/each of the two TCI states may not be associated with a pathloss offset. When TCI state configuration of the at least one TCI state comprises/indicates/contains a pathloss offset parameter (e.g., PathlossOffset, PlOffset, PathlossOffset in FIG. 19 and the like) and the control command (e.g., Control command in FIG. 20, DCI, MAC-CE) indicates two TCI states for the cell, both/each of the two TCI states may not be associated with a pathloss offset. The one or more configuration parameters may comprise the TCI state configuration. The wireless device may not expect both of the two TCI states being associated with a pathloss offset. The wireless device may not expect each TCI state of the two TCI states being associated with a pathloss offset. The wireless device may not be expected to be indicated, by the control command transmitted by the base station, with the two TCI states that are both associated with a pathloss offset. The base station may not transmit the control command indicating the two TCI states that are both associated with a pathloss offset.

In an example, both/each of the two TCI states may not be associated with a non-zero pathloss offset.

For example, the wireless device may not expect the first TCI state (or the first indicated TCI state) of the two TCI states being associated with a pathloss offset and the second TCI state (or the second indicated TCI state) of the two TCI states being associated with a pathloss offset.

When the one or more configuration parameters indicate, for at least one TCI state among the plurality of TCI states in the TCI state list, a pathloss offset and the control command (e.g., Control command in FIG. 20, DCI, MAC-CE) indicates two TCI states for the cell, one of the two TCI states may be associated with a pathloss offset. When TCI state configuration of the at least one TCI state comprises/indicates/contains a pathloss offset parameter (e.g., PathlossOffset, PlOffset, PathlossOffset in FIG. 19 and the like) and the control command (e.g., Control command in FIG. 20, DCI, MAC-CE) indicates two TCI states for the cell, one of the two TCI states may be associated with a pathloss offset. The one or more configuration parameters may comprise the TCI state configuration. The wireless device may not expect none of the two TCI states being associated with a pathloss offset (for example, including pathloss offset=0). The wireless device may expect one of the two TCI states being associated with a pathloss offset. The wireless device may not be expected to be indicated, by the control command transmitted by the base station, with the two TCI states that are both not associated with a pathloss offset. The base station may not transmit the control command indicating the two TCI states that are both not associated with a pathloss offset. The wireless device may be expected to be indicated, by the control command transmitted by the base station, with the two TCI states that comprise one TCI state associated with a pathloss offset. The base station may transmit the control command indicating the two TCI states that comprise one TCI state associated with a pathloss offset.

In an example, the one of the two TCI states may be associated with a non-zero pathloss offset.

For example, the wireless device may not expect the first TCI state (or the first indicated TCI state) of the two TCI states not being associated with a pathloss offset and the second TCI state (or the second indicated TCI state) of the two TCI states not being associated with a pathloss offset.

For example, the first TCI state (or the first indicated TCI state) of the two TCI states may be associated with a pathloss offset and the second TCI state (or the second indicated TCI state) of the two TCI states may not be associated with a pathloss offset. The wireless device may expect the first TCI state (or the first indicated TCI state) of the two TCI states being associated with a pathloss offset and the second TCI state (or the second indicated TCI state) of the two TCI states not being associated with a pathloss offset.

For example, the second TCI state (or the second indicated TCI state) of the two TCI states may be associated with a pathloss offset and the first TCI state (or the first indicated TCI state) of the two TCI states may not be associated with a pathloss offset. The wireless device may expect the second TCI state (or the second indicated TCI state) of the two TCI states being associated with a pathloss offset and the first TCI state (or the first indicated TCI state) of the two TCI states not being associated with a pathloss offset.

The control command (e.g., Control command in FIG. 20, DCI, MAC-CE) may indicate two TCI states for the cell, for example, based on the one or more configuration parameters indicating, for the cell, the two TAGs. The control command (e.g., Control command in FIG. 20, DCI, MAC-CE) may indicate two TCI states for the cell, for example, based on the one or more configuration parameters comprising the second TAG identifier/index/identity (e.g., tag2-Id). The base station may transmit the control command indicating the two TCI states for the cell, for example, based on the one or more configuration parameters comprising the second TAG identifier/index/identity (e.g., tag2-Id). The wireless device may expect to be indicated with two TCI states for the cell, for example, based on the one or more configuration parameters comprising the second TAG identifier/index/identity (e.g., tag2-Id). The one or more TCI states indicated by the control command may be the two TCI states.

The control command (e.g., Control command in FIG. 20, DCI, MAC-CE) may not indicate one/single TCI state for the cell, for example, based on the one or more configuration parameters indicating, for the cell, the two TAGs. The control command (e.g., Control command in FIG. 20, DCI, MAC-CE) may not indicate one/single TCI state for the cell, for example, based on the one or more configuration parameters comprising the second TAG identifier/index/identity (e.g., tag2-Id). The base station may not transmit the control command indicating one/singe TCI state for the cell, for example, based on the one or more configuration parameters comprising the second TAG identifier/index/identity (e.g., tag2-Id). The wireless device may not expect to be indicated with one/single TCI state for the cell, for example, based on the one or more configuration parameters comprising the second TAG identifier/index/identity (e.g., tag2-Id). The one or more TCI states indicated by the control command may not be one TCI state.

In an example, the one or more TCI states may be one TCI state (or a single TCI state). The one or more TCI states may be the first TCI state (or the first indicated TCI state).

The first TCI state may be associated with a TAG of the two TAGs of the cell.

The one or more configuration parameters may indicate, for the first TCI state, a first TAG pointer (e.g., tag-Id-ptr in FIG. 19) indicating the TAG. The first TCI state configuration of the first TCI state may comprise/have/indicate/provide a first TAG pointer (e.g., tag-Id-ptr in FIG. 19) indicating/identifying the TAG associated with the first TCI state. A first value (e.g., n0) of the first TAG pointer may indicate the first TAG identified/indicated by the first TAG identifier/index/identity (e.g., tag-Id). The TAG associated with the first TCI state may be the first TAG when the first TAG pointer is set to the first value. A second value (e.g., n1) of the first TAG pointer may indicate the second TAG identified/indicated by the second TAG identifier/index/identity (e.g., tag2-Id). The TAG associated with the first TCI state may be the second TAG when the first TAG pointer is set to the second value.

The wireless device may receive an activation command.

The activation command may be, for example, a random-access response (RAR). The wireless device may receive the RAR (or MAC-RAR) based on (or after) transmitting the PRACH transmission. The RAR may correspond to the PRACH transmission. The wireless device may receive the RAR, for example, for the random-access procedure. The wireless device may monitor (or start monitoring), for the RAR, for example, after transmitting the PRACH transmission.

The activation command may be, for example, an absolute Timing Advance Command MAC CE.

The activation command may comprise a timing advance command (or a timing advance command field) with a value used to control the amount of timing adjustment that the wireless device has to apply for uplink transmissions via the cell.

The activation command may comprise a TAG indicator (TI) field.

In an example, the wireless device may ignore the TI field in the activation command. The wireless device may ignore the TI field in the activation command, for example, based on the one or more TCI states being one TCI state (or a single TCI state). The wireless device may ignore the TI field in the activation command, for example, based on the wireless device being indicated, by the control command, with one TCI state (or a single TCI state) for the cell.

The wireless device may apply the timing advance command for the TAG associated with the first TCI state. The wireless device may apply the timing advance command for the TAG associated with the first TCI state, for example, based on the wireless device being indicated, by the control command, with one TCI state (or a single TCI state) for the cell. The one TCI state (or a single TCI state) for the cell is the first TCI state.

The wireless device may apply the timing advance command for the TAG associated with the first TCI state, for example, based on (or after) ignoring the TI field in the activation command.

The TI field in the activation command may indicate the TAG associated with the first TCI state. A value of the TI field in the activation command may indicate the TAG associated with the first TCI state. The TI field in the activation command may indicate the TAG associated with the first TCI state, for example, based on the one or more TCI states being one TCI state (or a single TCI state). The TI field in the activation command may indicate the TAG associated with the first TCI state, for example, based on the wireless device being indicated, by the control command, with one TCI state (or a single TCI state) for the cell. The one TCI state (or a single TCI state) for the cell is the first TCI state.

The TI field in the activation command may not indicate a TAG, among the two TAGs of the cell, different from the TAG associated with the first TCI state. A value of the TI field in the activation command may not indicate a TAG, among the two TAGs of the cell, different from the TAG associated with the first TCI state. The TI field in the activation command may not indicate a TAG, among the two TAGs of the cell, different from the TAG associated with the first TCI state, for example, based on the one or more TCI states being one TCI state (or a single TCI state). The TI field in the activation command may not indicate a TAG, among the two TAGs of the cell, different from the TAG associated with the first TCI state, for example, based on the wireless device being indicated, by the control command, with one TCI state (or a single TCI state) for the cell. The one TCI state (or a single TCI state) for the cell is the first TCI state.

The wireless device may apply the timing advance command for the TAG associated with the first TCI state. The wireless device may apply the timing advance command for the TAG associated with the first TCI state, for example, based on the TI field in the activation command indicating the TAG associated with the first TCI state.

In an example, the TAG associated with the first TCI state may be the first TAG identified/indicated by the first TAG identifier/index/identity (e.g., tag-Id). The one or more configuration parameters may comprise a tag flag parameter (e.g., tag2-flag) set to true. The value of the TI field in the activation command may be set/equal to a second value (e.g., 1), for example, based on the first TCI state being associated with the first TAG identified/indicated by the first TAG identifier/index/identity (e.g., tag-Id). When the tag flag parameter (e.g., tag2-flag) is set to true, the second value of the TI field may indicate the first TAG identified/indicated by the first TAG identifier/index/identity (e.g., tag-Id).

In an example, the TAG associated with the first TCI state may be the first TAG identified/indicated by the first TAG identifier/index/identity (e.g., tag-Id). The one or more configuration parameters may comprise a tag flag parameter (e.g., tag2-flag) that is not set to true. The value of the TI field in the activation command may be set/equal to a first value (e.g., 0), for example, based on the first TCI state being associated with the first TAG identified/indicated by the first TAG identifier/index/identity (e.g., tag-Id). When the tag flag parameter (e.g., tag2-flag) is not set to true, the first value of the TI field may indicate the first TAG identified/indicated by the first TAG identifier/index/identity (e.g., tag-Id).

In an example, the TAG associated with the first TCI state may be the first TAG identified/indicated by the first TAG identifier/index/identity (e.g., tag-Id). The one or more configuration parameters may not comprise a tag flag parameter (e.g., tag2-flag). The value of the TI field in the activation command may be set/equal to a first value (e.g., 0), for example, based on the first TCI state being associated with the first TAG identified/indicated by the first TAG identifier/index/identity (e.g., tag-Id). When the tag flag parameter (e.g., tag2-flag) is not configured/present (or is absent) in the one or more configuration parameters, the first value of the TI field may indicate the first TAG identified/indicated by the first TAG identifier/index/identity (e.g., tag-Id).

In an example, the TAG associated with the first TCI state may be the second TAG identified/indicated by the second TAG identifier/index/identity (e.g., tag2-Id). The one or more configuration parameters may comprise a tag flag parameter (e.g., tag2-flag) set to true. The value of the TI field in the activation command may be set/equal to a first value (e.g., 0), for example, based on the first TCI state being associated with the second TAG identified/indicated by the second TAG identifier/index/identity (e.g., tag2-Id). When the tag flag parameter (e.g., tag2-flag) is set to true, the first value of the TI field may indicate the second TAG identified/indicated by the second TAG identifier/index/identity (e.g., tag2-Id).

In an example, the TAG associated with the first TCI state may be the second TAG identified/indicated by the second TAG identifier/index/identity (e.g., tag2-Id). The one or more configuration parameters may comprise a tag flag parameter (e.g., tag2-flag) that is not set to true. The value of the TI field in the activation command may be set/equal to a second value (e.g., 1), for example, based on the first TCI state being associated with the second TAG identified/indicated by the second TAG identifier/index/identity (e.g., tag2-Id). When the tag flag parameter (e.g., tag2-flag) is not set to true, the second value of the TI field may indicate the second TAG identified/indicated by the second TAG identifier/index/identity (e.g., tag2-Id).

In an example, the TAG associated with the first TCI state may be the second TAG identified/indicated by the second TAG identifier/index/identity (e.g., tag2-Id). The one or more configuration parameters may not comprise a tag flag parameter (e.g., tag2-flag). The value of the TI field in the activation command may be set/equal to a second value (e.g., 1), for example, based on the first TCI state being associated with the second TAG identified/indicated by the second TAG identifier/index/identity (e.g., tag2-Id). When the tag flag parameter (e.g., tag2-flag) is not configured/present (or is absent) in the one or more configuration parameters, the second value of the TI field may indicate the second TAG identified/indicated by the second TAG identifier/index/identity (e.g., tag2-Id).

When a wireless device is configured with dl-OrJointTCI-StateList, is having one indicated TCI state, and a field (e.g., pathloss offset indicator field) is present in DCI format 1_0 (or in PDCCH order), if/when the indicated TCI state is not associated with a pathloss offset, the wireless device may ignore the field in the DCI format 1_0.

When a wireless device is configured with dl-OrJointTCI-StateList, is having one indicated TCI state, and a field (e.g., pathloss offset indicator field) is present in DCI format 1_0 (or in PDCCH order), if/when the indicated TCI state is not associated with a pathloss offset, the wireless device may not be expected to receive, from a base station, the DCI format 1_0 with the field (e.g., pathloss offset indicator field) set to a second value (e.g., 1). The wireless device may be expected to receive, from the base station, the DCI format 1_0 with the field set to a first value (e.g., 0).

When a base station transmits, to a wireless device, RRC message(s) comprising dl-OrJointTCI-StateList, and transmits a control command (e.g., DCI, MAC-CE) indicating one TCI state, and a field (e.g., pathloss offset indicator field) is present in DCI format 1_0 (or in PDCCH order), if/when the indicated TCI state is not associated with a pathloss offset, the base station may not transmit, to the wireless device, the DCI format 1_0 with the field (e.g., pathloss offset indicator field) set to a second value (e.g., 1). The base station may transmit, to the wireless device, the DCI format 1_0 with the field set to a first value (e.g., 0).

The indicated TCI state may not be associated with a pathloss offset, for example, when a pathloss offset parameter (e.g., pathlossOffset, PlOffset) is not configured/indicated for the indicated TCI state by RRC message(s).

The indicated TCI state may not be associated with a pathloss offset, for example, a pathloss offset parameter (e.g., pathlossOffset, PlOffset) configured/indicated for the indicated TCI state is equal/set/indicated to/as zero, for example, by RRC message(s) or MAC-CE.

The DCI format 1_0 (or the PDCCH order) may initiate/trigger a random-access procedure. The wireless device may transmit, for the random-access procedure, a PRACH transmission using a transmission power. The wireless device may determine/calculate the transmission power using a pathloss reference signal. The base station may receive the PRACH transmission.

When the indicated TCI state is associated with a pathloss offset, the bit field index 0 of the field (e.g., the pathloss offset indicator field) may indicate that the pathloss reference signal for the PRACH transmission is the downlink reference signal that the DM-RS of the PDCCH order is quasi-collocated with, and the bit field index 1 of the field may indicate that the pathloss reference signal for the PRACH transmission is the pathloss reference signal associated with the indicated TCI state.

When a wireless device is configured with dl-OrJointTCI-StateList, is having two indicated TCI states, and a field (e.g., pathloss offset indicator field) is present in DCI format 1_0 (or in PDCCH order), if/when each/any of the two indicated TCI states is not associated with a pathloss offset, the wireless device may ignore the field in the DCI format 1_0.

When a wireless device is configured with dl-OrJointTCI-StateList, is having two indicated TCI states, and a field (e.g., pathloss offset indicator field) is present in DCI format 1_0 (or in PDCCH order), if/when each/any of the two indicated TCI states is not associated with a pathloss offset, the field may indicate the pathloss reference signal for the PRACH transmission. The field may indicate the pathloss reference signal for the PRACH transmission, for example, if the wireless device is not provided/configured/indicated, by RRC message(s), with SSB-MTC-AddtionalPCI. The bit field index 0 of the field (e.g., pathloss offset indicator field) may be mapped to the downlink reference signal that the DM-RS of the PDCCH order is quasi-collocated with, and the bit field index 1 of the field (e.g., pathloss offset indicator field) may be mapped to an SS/PBCH indicated by the SS/PBCH index field in the DCI format 1_0 (or the PDCCH order). The bit field index 0 of the field (e.g., the pathloss offset indicator field) may indicate that the pathloss reference signal for the PRACH transmission is the downlink reference signal that the DM-RS of the PDCCH order is quasi-collocated with, and the bit field index 1 of the field may indicate that the pathloss reference signal for the PRACH transmission is the SS/PBCH indicated by the SS/PBCH index field in the DCI format 1_0 (or the PDCCH order).

When a wireless device is configured with dl-OrJointTCI-StateList, is having two indicated TCI states, and a field (e.g., pathloss offset indicator field) is present in DCI format 1_0 (or in PDCCH order), if the first indicated TCI state of the two indicated TCI states is associated with a pathloss offset, the bit field index 0 of the field may indicate that the pathloss offset associated with the first indicated TCI state is included/used in/for calculation of the transmission power for/of the PRACH transmission, and the pathloss reference signal for the PRACH transmission is the pathloss reference signal associated with the first indicated TCI state.

When a wireless device is configured with dl-OrJointTCI-StateList, is having two indicated TCI states, and a field (e.g., pathloss offset indicator field) is present in DCI format 1_0 (or in PDCCH order), if the first indicated TCI state of the two indicated TCI states is not associated with a pathloss offset, the bit field index 0 of the field may indicate that the pathloss reference signal for the PRACH transmission is the downlink reference signal that the DM-RS of the PDCCH order is quasi-collocated with.

When a wireless device is configured with dl-OrJointTCI-StateList, is having two indicated TCI states, and a field (e.g., pathloss offset indicator field) is present in DCI format 1_0 (or in PDCCH order), if the second indicated TCI state of the two indicated TCI states is associated with a pathloss offset, the bit field index 1 of the field may indicate that the pathloss offset associated with the second indicated TCI state is included/used in/for calculation of the transmission power for/of the PRACH transmission, and the pathloss reference signal for the PRACH transmission is the pathloss reference signal associated with the second indicated TCI state.

When a wireless device is configured with dl-OrJointTCI-StateList, is having two indicated TCI states, and a field (e.g., pathloss offset indicator field) is present in DCI format 1_0 (or in PDCCH order), if the second indicated TCI state of the two indicated TCI states is not associated with a pathloss offset, the bit field index 1 of the field may indicate that the pathloss reference signal for the PRACH transmission is the downlink reference signal that the DM-RS of the PDCCH order is quasi-collocated with.

The indicated TCI state may be associated with a pathloss offset, for example, when a pathloss offset parameter (e.g., pathlossOffset, PlOffset) is configured/indicated for the indicated TCI state by RRC message(s).

The indicated TCI state may be associated with a pathloss offset, for example, a pathloss offset parameter (e.g., pathlossOffset, PlOffset) configured/indicated for the indicated TCI state is equal/set/indicated to/as a non-zero value, for example, by RRC message(s) or MAC-CE.

DCI format 1_0 may be used for the scheduling of PDSCH in one downlink cell.

The following information may be transmitted by means of the DCI format 1_0 with CRC scrambled by C-RNTI or CS-RNTI or MCS-C-RNTI:

Frequency domain resource assignment field: If the CRC of the DCI format 1_0 is scrambled by C-RNTI and the “Frequency domain resource assignment” field are set to one, the DCI format 1_0 may be for a random access procedure initiated by a PDCCH order, with all remaining fields set as follows:

Random Access Preamble index—6 bits according to ra-PreambleIndex.

UL/SUL indicator—1 bit. If the value of the “Random Access Preamble index” is not all zeros and if the wireless device is configured with supplementaryUplink in ServingCellConfig in the cell, this field may indicate which UL carrier in the cell to transmit the PRACH transmission; otherwise, this field is reserved.

SS/PBCH index—6 bits. If the value of the “Random Access Preamble index” is not all zeros, this field may indicate an SS/PBCH that may be used to determine the RACH occasion for the PRACH transmission; otherwise, this field is reserved.

PRACH Mask index—4 bits. If the value of the “Random Access Preamble index” is not all zeros, this field may indicate the RACH occasion associated with the SS/PBCH indicated by “SS/PBCH index” for the PRACH transmission; otherwise, this field is reserved.

Cell indicator—┌ log₂(C+1)┐ bits indicating the cell for the corresponding PRACH transmission if the wireless device is configured with higher layer parameter EarlyUlSyncConfig, where C is the number of candidate cells configured with higher layer parameter EarlyUlSyncConfig; 0 bit otherwise.

PRACH association indicator—0 or 1 bit

1 bit if the wireless device is provided/configured/indicated, by the base station, with a higher layer parameter tag-Id2, and the wireless device is not provided/configured/indicated coresetPoolIndex or is provided coresetPoolIndex with value 0 for the first CORESETs, and is provided coresetPoolIndex with value 1 for the second CORESETs, or

This field may indicate the PCI associated with the PRACH transmission if the wireless device is provided SSB-MTC-AddtionalPCI. The bit field index 0 of this field may be mapped to the PCI of the serving cell, and the bit field index 1 of this field may be mapped to the active additional PCI.

This field may indicate the PL-RS for the PRACH transmission if the wireless device is not provided/configured/indicated a higher layer parameter SSB-MTC-AddtionalPCI. The bit field index 0 of this field may be mapped to the DL RS that the DM-RS of the PDCCH order is quasi co-located with, and the bit field index 1 of this field may be mapped to the SS/PBCH indicated by the SS/PBCH index field in this DCI format.

0 bit otherwise.

Pathloss offset indicator—0 or 1 bit

1 bit if the wireless device is provided/configured/indicated, by the base station, with a higher layer parameter tag2-Id, is provided/configured/indicated, by the base station, with a higher layer parameter (e.g., pathlossOffsetIndicationDCI-1-0, pathlossOffset-PresentInDCI) (or the higher layer parameter is present or is configured to ‘enabled), and at least one configured TCI state for the serving cell contains pathloss offset (or a pathloss offset parameter (e.g., pathlossOffset, PlOffset)). This field may be reserved if the cell indicated by Cell indicator field is a candidate cell.

0 bit otherwise.

When a wireless device is provided/configured/indicated, by RRC message(s) transmitted by a base station, with a higher layer parameter dl-OrJointTCI-StateList and provided/configured/indicated, by the RRC messages, with a higher layer parameter tag2-Id, the wireless device may expect to be indicated, by a control command transmitted by the base station, with two TCI states (or the wireless device may not expect to be indicated with one TCI state).

When a base station transmits, to a wireless device, RRC message(s) comprising a higher layer parameter dl-OrJointTCI-StateList and comprising a higher layer parameter tag2-Id, the base station may transmit, to the wireless device, a control command (e.g., DCI, MAC-CE) indicating two TCI states (or the base station may not transmit a control command indicating one TCI state).

When a wireless device is provided/configured/indicated, by RRC message(s) transmitted by a base station, with a higher layer parameter dl-OrJointTCI-StateList and provided/configured/indicated, by the RRC messages, with a higher layer parameter tag2-Id, and is having one indicated TCI state, the wireless device may expect a value of the TI field, in an activation command (e.g., Absolute Timing Advance Command MAC CE or MAC random-access response (RAR)), to indicate a TAG associated with the indicated TCI state.

When the base station transmits, to the wireless device, RRC message(s) comprising the higher layer parameter dl-OrJointTCI-StateList and comprising the higher layer parameter tag2-Id, and transmits a control command (e.g., DCI, MAC-CE) indicating one TCI state, the base station may transmit, to the wireless device, the activation command indicating the TAG associated with the indicated TCI state.

When a wireless device is provided/configured/indicated, by RRC message(s) transmitted by a base station, with a higher layer parameter dl-OrJointTCI-StateList and provided/configured/indicated, by the RRC messages, with a higher layer parameter tag2-Id, and is having one indicated TCI state, the wireless device may not expect the value of the TI field, in the activation command, to indicate a TAG that is not associated with the indicated TCI state.

When the base station transmits, to the wireless device, RRC message(s) comprising the higher layer parameter dl-OrJointTCI-StateList and comprising the higher layer parameter tag2-Id, and transmits the control command (e.g., DCI, MAC-CE) indicating one TCI state, the base station may not transmit, to the wireless device, the activation command that is indicating a TAG associated with the indicated TCI state.

When a wireless device is provided/configured/indicated, by RRC message(s) transmitted by a base station, with a higher layer parameter dl-OrJointTCI-StateList and provided/configured/indicated, by the RRC messages, with a higher layer parameter tag2-Id, and is having one indicated TCI state, the wireless device may expect a value of the TI field, in an activation command (e.g., Absolute Timing Advance Command MAC CE or MAC random-access response (RAR)), the wireless device may ignore the value of the TI field in the activation command, and may apply the timing advance command, in the activation command, to the TAG associated with the indicated TCI state.

What is claimed is:

1. A wireless device comprising:
one or more processors; and
memory storing instructions that, when executed by the one or more processors, cause the wireless device to:
receive one or more radio resource control (RRC) messages comprising one or more configuration parameters for a cell, wherein:
the one or more configuration parameters comprise a pathloss offset parameter, for a downlink bandwidth part (BWP) of the cell, indicating that a pathloss offset indicator field is present in a downlink control information (DCI) format; and
the pathloss offset indicator field indicates a pathloss offset for a physical random-access channel (PRACH) transmission initiated by a physical downlink control channel (PDCCH) order;
receive, based on the DCI format, a first PDCCH order initiating a random-access procedure via the cell, wherein:
the first PDCCH order comprises the pathloss offset indicator field; and
a value of the pathloss offset indicator field indicates to apply a first pathloss offset associated with a first transmission configuration indicator (TCI) state to a first PRACH transmission; and
transmit, for the random-access procedure, the first PRACH transmission using a transmission power based on the first pathloss offset.

2. The wireless device of claim 1, wherein the transmission power is calculated using a downlink pathloss estimate of a demodulation reference signal (DM-RS) of the PDCCH order minus the first pathloss offset.

3. The wireless device of claim 1, wherein a size of the pathloss offset indicator field is one bit.

4. The wireless device of claim 1, wherein the first PDCCH order comprises the pathloss offset indicator field based on the pathloss offset parameter being present in the one or more configuration parameters and set to the value of enabled.

5. The wireless device of claim 1, wherein:
the one or more configuration parameters comprise a TCI state list parameter indicating a list of TCI states for the downlink BWP of the cell; and
at least one TCI state from the list of TCI states is associated with the pathloss offset.

6. The wireless device of claim 1, wherein a first DCI format of the first PDCCH order is the DCI format.

7. The wireless device of claim 1, wherein:
the pathloss offset parameter is a first pathloss offset parameter and the downlink BWP is a first downlink BWP; and
the one or more configuration parameters comprise a second pathloss offset parameter, for a second downlink BWP, indicating that the pathloss offset indicator field is present in the DCI format.

8. A base station comprising:
one or more processors; and
memory storing instructions that, when executed by the one or more processors, cause the base station to:
transmit, to a wireless device, one or more radio resource control (RRC) messages comprising one or more configuration parameters for a cell, wherein:
the one or more configuration parameters comprise a pathloss offset parameter, for a downlink bandwidth part (BWP) of the cell, indicating that a pathloss offset indicator field is present in a downlink control information (DCI) format; and
the pathloss offset indicator field indicates a pathloss offset for a physical random-access channel (PRACH) transmission initiated by a physical downlink control channel (PDCCH) order;
transmit, based on the DCI format, a first PDCCH order initiating a random-access procedure via the cell, wherein:
the first PDCCH order comprises the pathloss offset indicator field; and
a value of the pathloss offset indicator field indicates to apply a first pathloss offset associated with a first transmission configuration indicator (TCI) state to a first PRACH transmission; and
receive, for the random-access procedure, the first PRACH transmission transmitted by the wireless device using a transmission power based on the first pathloss offset.

9. The base station of claim 8, wherein the transmission power is calculated using a downlink pathloss estimate of a demodulation reference signal (DM-RS) of the PDCCH order minus the first pathloss offset.

10. The base station of claim 8, wherein a size of the pathloss offset indicator field is one bit.

11. The base station of claim 8, wherein the first PDCCH order comprises the pathloss offset indicator field based on the pathloss offset parameter being present in the one or more configuration parameters and set to the value of enabled.

12. The base station of claim 8, wherein:
the one or more configuration parameters comprise a TCI state list parameter indicating a list of TCI states for the downlink BWP of the cell; and
at least one TCI state from the list of TCI states is associated with the pathloss offset.

13. The base station of claim 8, wherein a first DCI format of the first PDCCH order is the DCI format.

14. The base station of claim 8, wherein:
the pathloss offset parameter is a first pathloss offset parameter and the downlink BWP is a first downlink BWP; and
the one or more configuration parameters comprise a second pathloss offset parameter, for a second downlink BWP, indicating that the pathloss offset indicator field is present in the DCI format.

15. A non-transitory computer-readable medium comprising instructions that, when executed by one or more processors of a wireless device, cause the wireless device to:
receive one or more radio resource control (RRC) messages comprising one or more configuration parameters for a cell, wherein:
the one or more configuration parameters comprise a pathloss offset parameter, for a downlink bandwidth part (BWP) of the cell, indicating that a pathloss offset indicator field is present in a downlink control information (DCI) format; and
the pathloss offset indicator field indicates a pathloss offset for a physical random-access channel (PRACH) transmission initiated by a physical downlink control channel (PDCCH) order;
receive, based on the DCI format, a first PDCCH order initiating a random-access procedure via the cell, wherein:
the first PDCCH order comprises the pathloss offset indicator field; and
a value of the pathloss offset indicator field indicates to apply a first pathloss offset associated with a first transmission configuration indicator (TCI) state to a first PRACH transmission; and
transmit, for the random-access procedure, the first PRACH transmission using a transmission power based on the first pathloss offset.

16. The non-transitory computer-readable medium of claim 15, wherein the transmission power is calculated using a downlink pathloss estimate of a demodulation reference signal (DM-RS) of the PDCCH order minus the first pathloss offset.

17. The non-transitory computer-readable medium of claim 15, wherein a size of the pathloss offset indicator field is one bit.

18. The non-transitory computer-readable medium of claim 15, wherein the first PDCCH order comprises the pathloss offset indicator field based on the pathloss offset parameter being present in the one or more configuration parameters and set to the value of enabled.

19. The non-transitory computer-readable medium of claim 15, wherein:
the one or more configuration parameters comprise a TCI state list parameter indicating a list of TCI states for the downlink BWP of the cell; and
at least one TCI state from the list of TCI states is associated with the pathloss offset.

20. The non-transitory computer-readable medium of claim 15, wherein a first DCI format of the first PDCCH order is the DCI format.

21. The non-transitory computer-readable medium of claim 15, wherein:
the pathloss offset parameter is a first pathloss offset parameter and the downlink BWP is a first downlink BWP; and
the one or more configuration parameters comprise a second pathloss offset parameter, for a second downlink BWP, indicating that the pathloss offset indicator field is present in the DCI format.
